(19) United States
(12) Patent Application Publication
(10) Pub. No.: US 2020/0026047 A1
(43) Pub. Date: Jan. 23, 2020

(54) IMAGING LENS AND IMAGING APPARATUS

(71) Applicant: SONY CORPORATION, TOKYO (JP)

(72) Inventors: MASAHARU HOSOI, KANAGAWA (JP); TAKESHI HATAKEYAMA, CHIBA (JP); MIKI SATO, KANAGAWA (JP)

(21) Appl. No.: 16/334,172

(22) PCT Filed: Sep. 20, 2017
(86) PCT No.: PCT/JP2017/033840

§ 371 Date: Mar. 18, 2019

(30) Foreign Application Priority Data
Nov. 8, 2016 (JP) 2016-218344

(51) Int. Cl. G02B 15/14; G03B 17/14; G02B 9/12

(52) U.S. Cl. CPC G02B 15/143; H04N 5/23248; G02B 9/12; G03B 17/14

(57) ABSTRACT

An imaging lens of the disclosure includes, in order from an object side toward an image plane side, a first lens group having positive refractive power and including a plurality of optical elements, a second lens group having positive refractive power, and a third lens group having negative refractive power. The second lens group travels in an optical axis direction upon focusing. The plurality of optical elements include, in order from the object side toward the image plane side, at least a first lens having positive refractive power and a second lens, and predetermined conditional expressions are satisfied.

### TECHNICAL FIELD

The disclosure relates to an imaging lens especially suitable for a large-diameter telescopic lens of an interchangeable-lens digital camera system, and to an imaging apparatus provided with such an imaging lens.

### BACKGROUND ART

A configuration is known, as a first configuration example of a large-diameter telescopic lens, that includes, in order from an object side toward an image plane side, a first lens group having positive refractive power, a second lens group having negative refractive power, and a third lens group having positive refractive power. A configuration is also known, as a second configuration example, that includes, in order from an object side toward an image plane side, a first lens group having positive refractive power, a second lens group having positive refractive power, and a third lens group having negative refractive power. The second lens group travels in an optical axis direction upon focusing, in each of the first and the second configuration examples.

### CITATION LIST

### Patent Literature

PTL 1: Japanese Unexamined Patent Application Publication No. 2012-88427

PTL 2: Japanese Unexamined Patent Application Publication No. 2012-2999

PTL 3: Japanese Unexamined Patent Application Publication No. 2012-189679

### SUMMARY OF THE INVENTION

In general, a weight is heavy in each of the above-described first and the second configuration examples. In recent years, a camera body having no reflex mirror, referred to as a mirrorless camera or a non-reflex camera, appears for an interchangeable-lens camera system. Such a camera body is small in size and light in weight, expanding its market rapidly. With a progress in size reduction of the camera body, there is a growing demand for a reduction in size and weight of a lens to be attached thereto, in particular, a telescopic lens.

It is desirable to provide an imaging lens that makes it possible to achieve a telescopic lens that is small in size and light in weight while maintaining high image-forming performance, and an imaging apparatus mounted with such an imaging lens.

A first imaging lens according to one embodiment of the disclosure includes, in order from an object side toward an image plane side: a first lens group having positive refractive power and including a plurality of optical elements; a second lens group having positive refractive power; and a third lens group having negative refractive power, the second lens group travels in an optical axis direction upon focusing, the plurality of optical elements include, in order from the object side toward the image plane side, at least a first lens having positive refractive power and a second lens, and the following conditional expressions are satisfied:

0.20<DL12/f<0.5 (1)

νdmin>15 (2)
where
DL12 is an air space between the first lens and the second lens,
f is a focal distance, in a d-line, of entire system upon infinity focusing, and
νdmin is a minimum value of Abbe numbers of the respective plurality of optical elements.

A first imaging apparatus according to one embodiment of the disclosure includes an imaging lens and an imaging device outputting an imaging signal that corresponds to an optical image formed by the imaging lens. The imaging lens is configured by the first imaging lens according to one embodiment of the disclosure described above.

A second imaging lens according to one embodiment of the disclosure includes, in order from an object side toward an image plane side: a first lens group having positive refractive power and including a plurality of optical elements; a second lens group having negative refractive power; and a third lens group having positive refractive power, the second lens group travels in an optical axis direction upon focusing, the plurality of optical elements include, in order from the object side toward the image plane side, at least a first lens having positive refractive power and a second lens, and the following conditional expressions are satisfied:

0.20<DL12/f<0.5 (1)

νdmin>15 (2)
where
DL12 is an air space between the first lens and the second lens,
f is a focal distance, in a d-line, of entire system upon infinity focusing, and
νdmin is a minimum value of Abbe numbers of the respective plurality of optical elements.

A second imaging apparatus according to one embodiment of the disclosure includes an imaging lens and an imaging device outputting an imaging signal that corresponds to an optical image formed by the imaging lens. The imaging lens is configured by the second imaging lens according to one embodiment of the disclosure described above.

The first and the second imaging lenses or the first and the second imaging apparatuses according to one embodiment of the disclosure each have a lens system having the three-group configuration as a whole, achieving optimization of a configuration of each of the groups.

The first and the second imaging lenses or the first and the second imaging apparatuses according to one embodiment of the disclosure each achieve the optimization of the configuration of each of the groups in the lens system having the three-group configuration as a whole. Hence, it is possible to achieve a telescopic lens that is small in size and light in weight while maintaining high image-forming performance.

It is to be noted that effects described here are not necessarily limiting. An effect may be any of effects described in the disclosure.

### BRIEF DESCRIPTION OF DRAWINGS

FIG. 1 is a lens cross-sectional view of a first configuration example of an imaging lens according to one embodiment of the disclosure.

FIG. 2 is a lens cross-sectional view of a second configuration example of the imaging lens.

FIG. 3 is a lens cross-sectional view of a third configuration example of the imaging lens.

FIG. 4 is a lens cross-sectional view of a fourth configuration example of the imaging lens.

FIG. 5 is a lens cross-sectional view of a fifth configuration example of the imaging lens.

FIG. 6 is a lens cross-sectional view of a sixth configuration example of the imaging lens.

FIG. 7 is a lens cross-sectional view of a seventh configuration example of the imaging lens.

FIG. 8 is a lens cross-sectional view of an eighth configuration example of the imaging lens.

FIG. 9 is a lens cross-sectional view of a ninth configuration example of the imaging lens.

FIG. 10 is an aberration diagram illustrating a longitudinal aberration upon infinity focusing (top), a longitudinal aberration upon focusing at a photographic magnification of 1/30 (middle), and a longitudinal aberration upon closest-distance focusing (bottom), in Numerical Working Example 1 in which specific numerical values are applied to the imaging lens illustrated in FIG. 1.

FIG. 11 is an aberration diagram illustrating a longitudinal aberration upon the infinity focusing (top), a longitudinal aberration upon the focusing at the photographic magnification of 1/30 (middle), and a longitudinal aberration upon the closest-distance focusing (bottom), in Numerical Working Example 2 in which specific numerical values are applied to the imaging lens illustrated in FIG. 2.

FIG. 12 is an aberration diagram illustrating a longitudinal aberration upon the infinity focusing (top), a longitudinal aberration upon the focusing at the photographic magnification of 1/30 (middle), and a longitudinal aberration upon the closest-distance focusing (bottom), in Numerical Working Example 3 in which specific numerical values are applied to the imaging lens illustrated in FIG. 3.

FIG. 13 is an aberration diagram illustrating a longitudinal aberration upon the infinity focusing (top), a longitudinal aberration upon the focusing at the photographic magnification of 1/30 (middle), and a longitudinal aberration upon the closest-distance focusing (bottom), in Numerical Working Example 4 in which specific numerical values are applied to the imaging lens illustrated in FIG. 4.

FIG. 14 is an aberration diagram illustrating a longitudinal aberration upon the infinity focusing (top), a longitudinal aberration upon the focusing at the photographic magnification of 1/30 (middle), and a longitudinal aberration upon the closest-distance focusing (bottom), in Numerical Working Example 5 in which specific numerical values are applied to the imaging lens illustrated in FIG. 5.

FIG. 15 is an aberration diagram illustrating a longitudinal aberration upon the infinity focusing (top), a longitudinal aberration upon the focusing at the photographic magnification of 1/30 (middle), and a longitudinal aberration upon the closest-distance focusing (bottom), in Numerical Working Example 6 in which specific numerical values are applied to the imaging lens illustrated in FIG. 6.

FIG. 16 is an aberration diagram illustrating a longitudinal aberration upon the infinity focusing (top), a longitudinal aberration upon the focusing at the photographic magnification of 1/30 (middle), and a longitudinal aberration upon the closest-distance focusing (bottom), in Numerical Working Example 7 in which specific numerical values are applied to the imaging lens illustrated in FIG. 7.

FIG. 17 is an aberration diagram illustrating a longitudinal aberration upon the infinity focusing (top), a longitudinal aberration upon the focusing at the photographic magnification of 1/30 (middle), and a longitudinal aberration upon the closest-distance focusing (bottom), in Numerical Working Example 8 in which specific numerical values are applied to the imaging lens illustrated in FIG. 8.

FIG. 18 is an aberration diagram illustrating a longitudinal aberration upon the infinity focusing (top), a longitudinal aberration upon the focusing at the photographic magnification of 1/30 (middle), and a longitudinal aberration upon the closest-distance focusing (bottom), in Numerical Working Example 9 in which specific numerical values are applied to the imaging lens illustrated in FIG. 9.

FIG. 19 is a block diagram illustrating a configuration example of an imaging apparatus.

FIG. 20 is a diagram illustrating a range of conditional expression (3).

### MODES FOR CARRYING OUT THE INVENTION

In the following, embodiments of the disclosure are described in detail with reference to the drawings. It is to be noted that the description is given in the following order.

### 0. Comparative Example

### 1. Basic Configuration of Lenses

### 2. Workings and Effects

### 3. Example of Application to Imaging Apparatus

### 4. Numerical Working Examples of Lenses

### 5. Other Embodiments

### 0. Comparative Example

PTL 1 (Japanese Unexamined Patent Application Publication No. 2012-88427) proposes an imaging lens that includes, in order from an object side toward an image plane side, a positive first lens group, a negative second lens group, and a positive third lens group, and in which the second lens group travels in an optical axis direction upon focusing. The imaging lens described in PTL 1 disposes DOE (diffraction optical element) within the first lens group to thereby widen an air space between a first lens and a second lens that are from the object side and to make an optical effective diameter of the second lens and that of any lens following the second lens small, achieving a weight reduction of a weight of an optical system as a whole.

PTL 2 (Japanese Unexamined Patent Application Publication No. 2012-2999) and PTL 3 (Japanese Unexamined Patent Application Publication No. 2012-189679) each propose, as a first configuration example, an imaging lens that includes, in order from an object side toward an image plane side, a positive first lens group, a negative second lens group, and a positive third lens group. They also each propose, as a second configuration example, an imaging lens that includes, in order from an object side toward an image plane side, a first lens group having positive refractive power, a second lens group having positive refractive power, and a third lens group having negative refractive power. The second lens group travels in an optical axis direction upon focusing, in each of the first and the second configuration examples. The imaging lenses described in PTL 2 and PTL 3 each dispose the diffraction optical element within the first lens group as with the imaging lens described in PTL 1 to thereby widen an air space between a first lens and a second lens that are from the object side and to make an optical effective diameter of the second lens and that of any lens following the second lens small, achieving a weight reduction of a weight of an optical system as a whole.

The imaging lenses according to Working Examples of the PTLs 1, 2, and 3 each have the diffraction optical element. In general, an imaging lens having the diffraction optical element can lead to a generation of intense flare when a high-luminance photographic object is photographed. Accordingly, the imaging lens having the diffraction optical element is considered as being not suitable for use by a professional user who photographs under a severe environment.

It is therefore desirable to provide a telescopic lens that is small in size and light in weight while maintaining high image-forming performance, without using the diffraction optical element.

### 1. Basic Configuration of Lenses

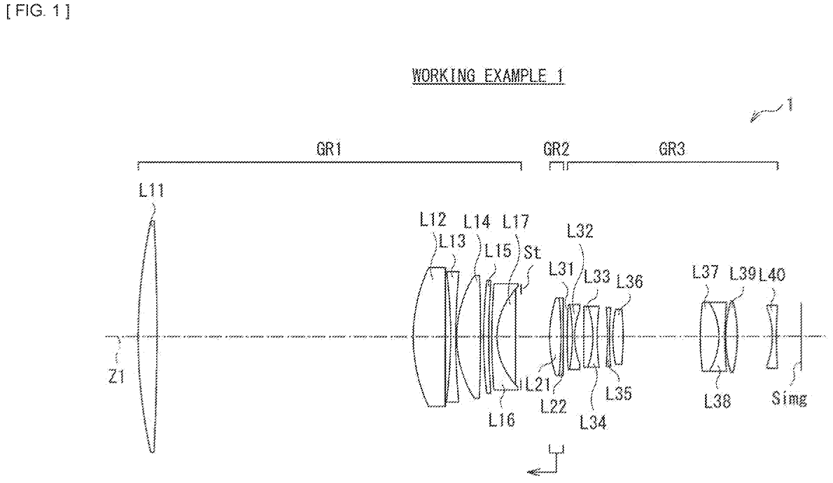

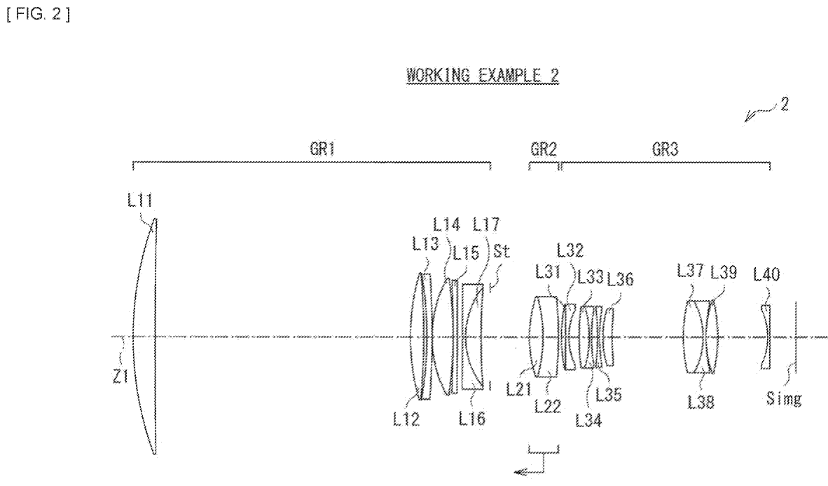

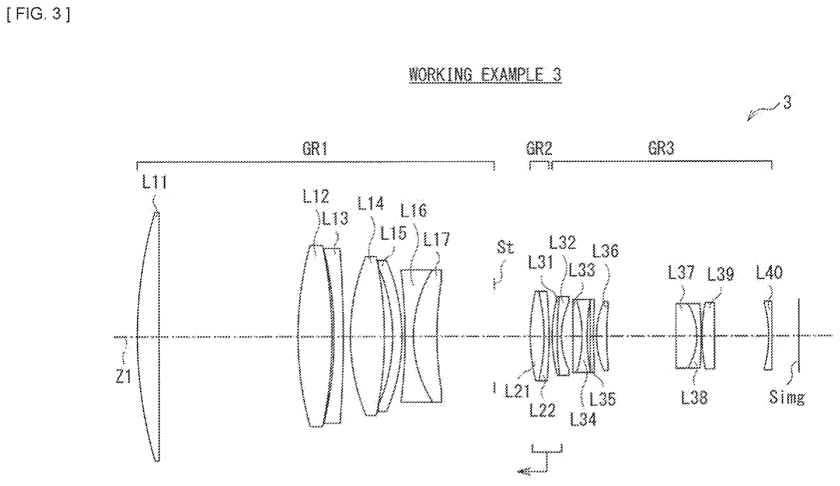

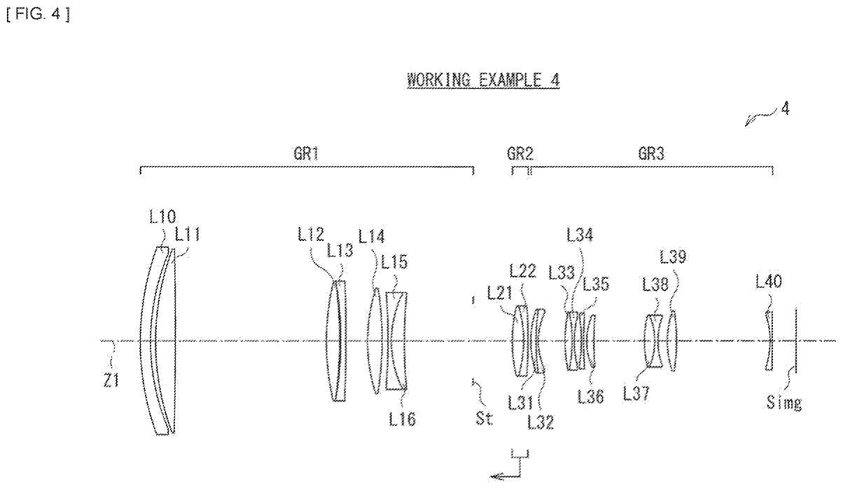

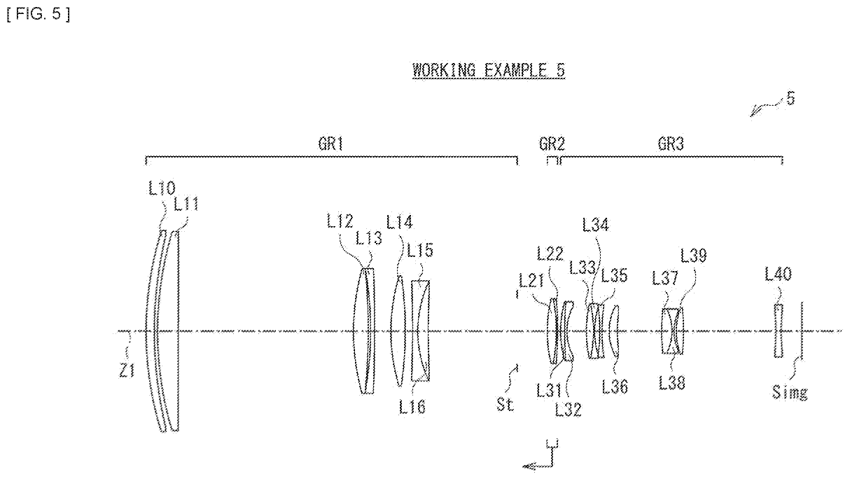

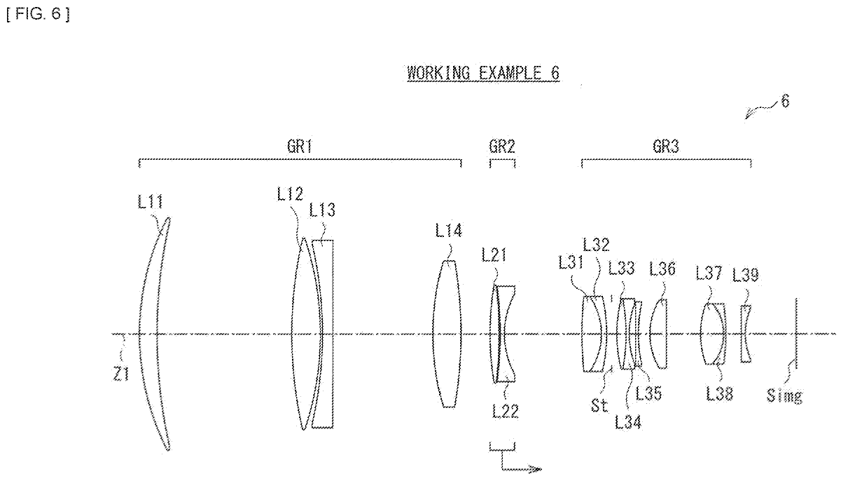

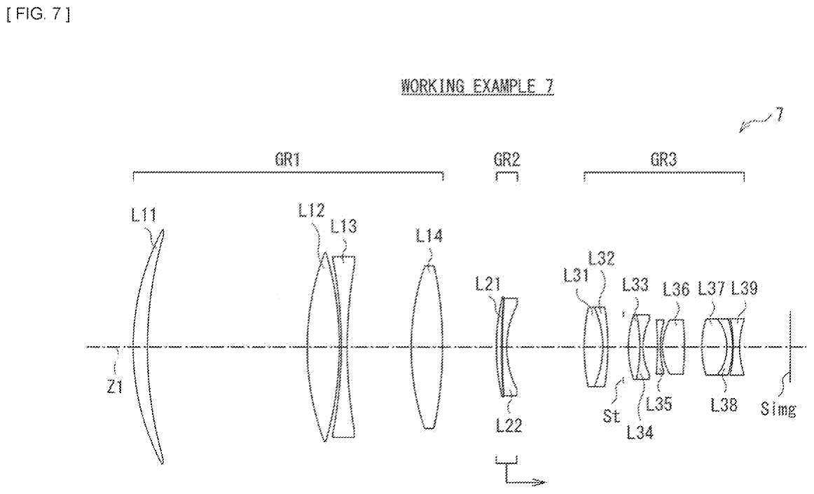

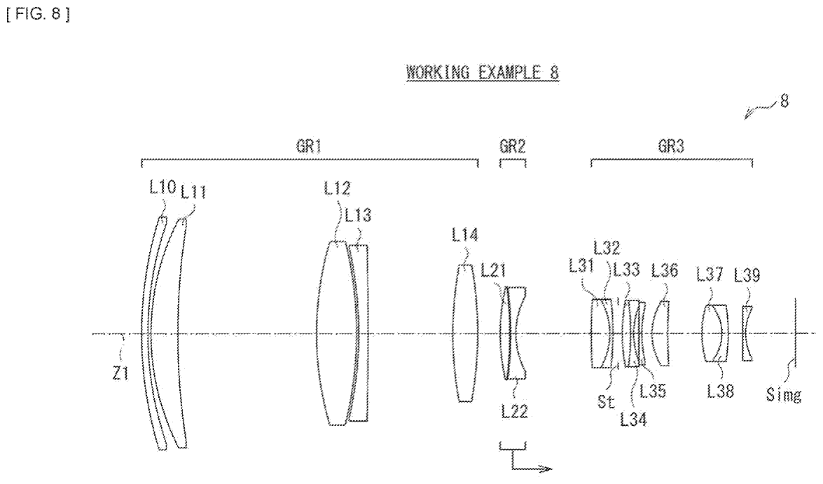

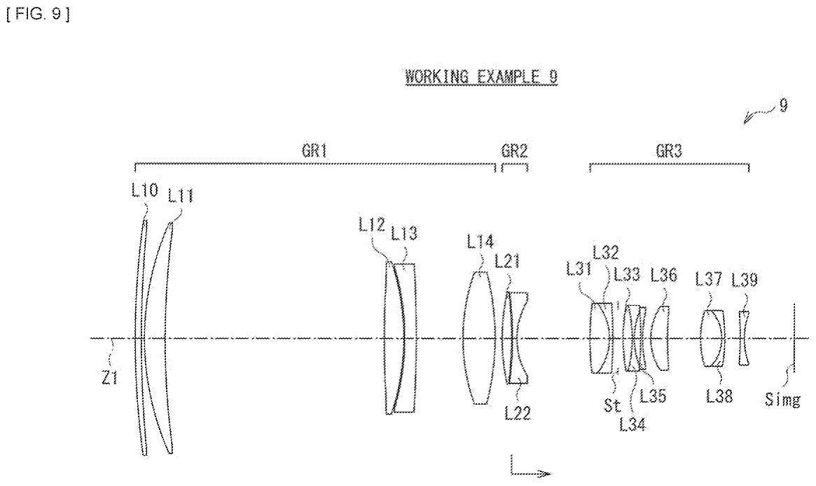

FIG. 1 illustrates a first configuration example of an imaging lens according to one embodiment of the disclosure. FIG. 2 illustrates a second configuration example of the imaging lens. FIG. 3 illustrates a third configuration example of the imaging lens. FIG. 4 illustrates a fourth configuration example of the imaging lens. FIG. 5 illustrates a fifth configuration example of the imaging lens. FIG. 6 illustrates a sixth configuration example of the imaging lens. FIG. 7 illustrates a seventh configuration example of the imaging lens. FIG. 8 illustrates an eighth configuration example of the imaging lens. FIG. 9 illustrates a ninth configuration example of the imaging lens. Numerical Working Examples in which specific numerical values are applied to those configuration examples are described later. In FIG. 1, etc., Z1 denotes an optical axis. Optical members such as a seal glass for protection of an imaging device or various kinds of optical filters may be provided between the imaging lens and an image plane Simg.

In the following, a configuration of the imaging lens according to the present embodiment is described in association with the configuration example illustrated in FIG. 1, etc., where appropriate. However, a technique of the disclosure is not limited to the illustrated configuration examples.

The imaging lens according to the present embodiment substantially includes three lens groups in which, in order from an object side toward an image plane side along the optical axis Z1, a first lens group GR1 having positive refractive power and including a plurality of optical elements, a second lens group GR2 having positive refractive power, and a third lens group GR3 having negative refractive power are disposed. In the following, this configuration is referred to as a first basic configuration. Configurations of FIG. 1 to FIG. 5 each correspond to the first basic configuration.

Further, the imaging lens according to the present embodiment may have a configuration in which the first lens group GR1 having the positive refractive power and including the plurality of optical elements, the second lens group GR2 having negative refractive power, and the third lens group GR3 having positive refractive power are disposed in order from the object side toward the image plane side along the optical axis Z1. In the following, this configuration is referred to as a second basic configuration. Configurations of FIG. 6 to FIG. 9 each correspond to the second basic configuration.

The second lens group GR2 travels in an optical axis direction upon focusing, in each of the imaging lenses having the respective first and second basic configurations.

Here, FIG. 1 to FIG. 9 each illustrate a lens cross-section upon infinity focusing. A solid line arrow indicates that the second lens group GR2 travels on the optical axis in the arrow direction as a focus lens group upon focusing from an object at infinity to an object at a short distance. The first lens group GR1 and the third lens group GR3 are fixed upon focusing.

In the imaging lens having the first basic configuration, the second lens group GR2 travels on the optical axis to the object side upon the focusing from the object at the infinity to the object at the short distance, as illustrated in FIG. 1 to FIG. 5.

In the imaging lens having the second basic configuration, the second lens group GR2 travels on the optical axis to the image plane side upon the focusing from the object at the infinity to the object at the short distance, as illustrated in FIG. 6 to FIG. 9.

In each of the imaging lenses having the respective first and second basic configurations, the plurality of optical elements within the first lens group GR1 include, in order from the object side toward the image plane side, at least a first lens L11 having positive refractive power and a second lens L12.

Besides those described above, it is desirable that the imaging lenses having the respective first and second basic configurations according to the present embodiment satisfy predetermined conditional expressions, etc., to be described later.

### 2. Workings and Effects

Next, description is given of workings and effects of the imaging lens according to the present embodiment. Description is also given together of a desirable configuration of the imaging lens according to the present embodiment.

It is to be noted that the effects described in the present specification are merely illustrative and non-limiting. Further, there may be any other effect as well.

The imaging lens according to the present embodiment achieves optimization of a configuration of each of the groups in a lens system having the three-group configuration as a whole, making it possible to achieve a telescopic lens that is small in size and light in weight while maintaining high image-forming performance.

The imaging lens according to the present embodiment has the three-group configuration of positive, positive, and negative or positive, negative, and positive in order from the object side toward the image plane side, allowing for convergence of light beams by the first lens group GR1 having the positive refractive power and thus making it possible to make small a diameter of the light beams entering the second lens groups GR2 that takes a role in a focus function. As a result, a diameter of the second lens group GR2 is made small as well, making it possible to reduce a weight of a lens. Reducing the weight of the lens also allows for a reduction in size of an actuator that moves the lens, which is advantageous in achieving a weight reduction.

It is desirable that the imaging lens according to the present embodiment satisfy the following conditional expression (1):

0.20<DL12/f<0.5 (1)
where
DL12 is an air space between the first lens L11 and the second lens L12, and
f is a focal distance, in a d-line, of the entire system upon the infinity focusing.

The conditional expression (1) is an expression in which the air space between the first lens L11 and the second lens L12 within the first lens group GR1 is normalized with respect to the focal distance of the entire system. Falling below an upper limit of the conditional expression (1) makes the air space excessively narrow, causing the light beams outputted from the first lens L11 to enter the second lens L12 without being subjected to the sufficient convergence. This leads to an increase in a lens diameter of the second lens L12 and that of any lens following the second lens L12, causing a weight of the lens system as a whole to be heavy. Further, exceeding the conditional expression (1) makes long an optical overall length of the lens system as a whole, causing the lens system as a whole to be large in size.

Incidentally, in order to better achieve an effect of the above-described conditional expression (1), it is more desirable that the numerical range of the conditional expression (1) be set as expressed by conditional expression (1)′ as follows. Satisfying the conditional expression (1)′ makes it possible to achieve a telescopic lens that is smaller in size and lighter in weight.

0.20<DL12/f<0.45 (1)′

Further, it is desirable that the imaging lens according to the present embodiment satisfy the following conditional expression (2):

νdmin>15 (2)
where
νdmin is a minimum value of Abbe numbers of the respective plurality of optical elements within the first lens group GR1.

The conditional expression (2) is an expression that defines the minimum value of the Abbe numbers of the respective plurality of optical elements within the first lens group GR1. Falling below the conditional expression (2) causes a chromatic aberration generated in an optical element to be excessively large, making it unable to correct a chromatic aberration, especially an on-axis chromatic aberration, generated within the first lens group GR1. Note that Abbe number of a diffraction optical element takes a negative value. Satisfying the conditional expression (2) results in no inclusion of the diffraction optical element in the plurality of optical elements within the first lens group.

Incidentally, in order to better achieve an effect of the above-described conditional expression (2), it is more desirable that the numerical range of the conditional expression (2) be set as expressed by conditional expression (2)′ as follows. Satisfying the conditional expression (2)′ makes it possible to achieve a telescopic lens that is smaller in size and lighter in weight.

νdmin>20 (2)′

Further, it is desirable that the imaging lens according to the present embodiment satisfy the following conditional expression (3):

1.53<ndL11<−1.036×10⁻⁶×νdL11³+2.481×10⁻⁴×νdL11²−1.996×10⁻²×νdL11+2.169 (3)
where
ndL11 is a refractive index, in a d-line, of the first lens L11, and
νdL11 is Abbe number of the first lens L11.

The conditional expression (3) is an expression that defines the refractive index of the first lens L11. Falling below the conditional expression (3) causes the refractive index to be excessively low, leading to a deterioration in a spherical aberration generated in the first lens L11. Exceeding the conditional expression (3) leads to use of a glass material having high specific gravity, causing a weight to be heavy.

Incidentally, in order to better achieve an effect of the above-described conditional expression (3), it is more desirable that the numerical range of the conditional expression (3) be set as expressed by conditional expression (3)′ as follows. Satisfying the conditional expression (3)′ makes it possible to achieve a telescopic lens that is smaller in size and lighter in weight.

1.57<ndL11<−1.036×10⁻⁶×νdL11³+2.481×10⁻⁴×νdL11²−1.996×10⁻²×νdL11+2.137 (3)′

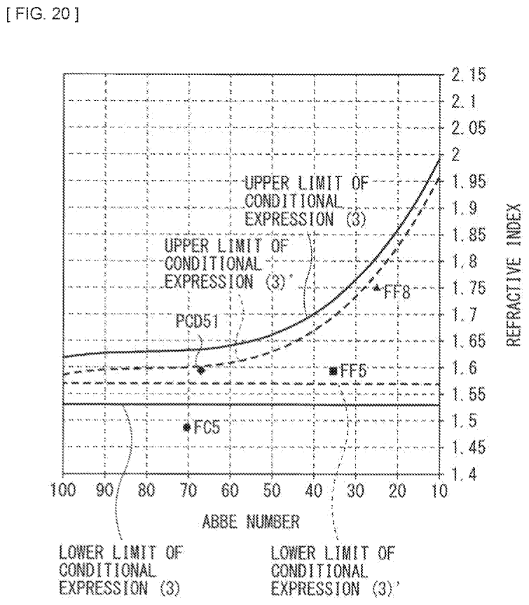

Here, FIG. 20 illustrates, in graph, the numerical ranges expressed by the conditional expressions (3) and (3)′. In FIG. 20, a horizontal axis denotes Abbe number and a vertical axis denotes a refractive index. For example, satisfying the conditional expression (3) is equivalent to using, for the first lens L11, a glass material that is in a range between a curve that indicates the upper limit of the conditional expression (3) and a curve that indicates the lower limit of the conditional expression (3) in FIG. 20. FF8, FF5, or PCD51 (names of glass materials manufactured by HOYA Corporation) is one example of the glass material that satisfies the conditional expression (3) or (3)′ as illustrated in FIG. 20. FC5 (name of a glass material manufactured by HOYA Corporation) is one example of the glass material that falls outside the conditional expression (3) or (3)′. FF8 and PCD51 each have specific gravity of 3.14, FF5 has specific gravity of 2.64, and FC5 has specific gravity of 2.45.

The imaging lens according to each of Numerical Working Examples to be described later uses any of the glass materials of FF8, FF5, and PCD51 for the first lens L11. Specifically, PCD51 is used for the first lens L11 in each of the Numerical Working Examples 1 and 2. FF8 is used for the first lens L11 in each of the Numerical Working Examples 3 and 7. FF5 is used for the first lens L11 in each of the Numerical Working Examples 4, 5, 6, 8, and 9.

Further, it is desirable that the imaging lens according to the present embodiment satisfy the following conditional expression (4):

0.3<fL11/f1<2.7 (4)
where
fL11 is a focal distance, in the d-line, of the first lens L11, and
f1 is a focal distance, in a d-line, of the first lens group GR1 as a whole.

The conditional expression (4) is an expression in which the focal distance of the first lens L11 is normalized with respect to the focal distance of the first lens group GR1 as a whole. Falling below the conditional expression (4) makes power of the first lens L11 strong, leading to a deterioration in an aberration, especially a spherical aberration, generated in the first lens L11. Further, exceeding the conditional expression (4) makes the power of the first lens L11 weak, causing the light beams outputted from the first lens L11 to enter the second lens L12 without being subjected to the sufficient convergence. This leads to the increase in the lens diameter of the second lens L12 and that of any lens following the second lens L12, causing a weight of a lens to be heavy.

Incidentally, in order to better achieve an effect of the above-described conditional expression (4), it is more desirable that the numerical range of the conditional expression (4) be set as expressed by conditional expression (4)′ as follows. Satisfying the conditional expression (4)′ makes it possible to achieve a telescopic lens that is smaller in size and lighter in weight, and that has higher image-forming performance.

0.4<fL11/f1<2.55 (4)′

Further, in the imaging lens according to the present embodiment, it is desirable that the plurality of optical elements within the first lens group GR1 further include a negative lens that satisfies the following conditional expression (5):

νdn<30 (5)
where
νdn is Abbe number of the above-described negative lens.

Exceeding the conditional expression (5) leads to a deterioration in an on-axis chromatic aberration.

Incidentally, in order to better achieve an effect of the above-described conditional expression (5), it is more desirable that the numerical range of the conditional expression (5) be set as expressed by conditional expression (5)′ as follows. Satisfying the conditional expression (5)′ makes it possible to achieve a telescopic lens having higher image-forming performance.

νdn<26 (5)′

Further, in the imaging lens according to the present embodiment, it is desirable that the plurality of optical elements within the first lens group GR1 further include a negative lens that satisfies the following conditional expression (6):

ΘgFn>0.55 (6)
where
ΘgFn is a partial dispersion ratio of the above-described negative lens.

The conditional expression (6) is an expression that defines the partial dispersion ratio of the above-described negative lens. Falling below the conditional expression (6) leads to a deterioration in a chromatic aberration, especially an on-axis chromatic aberration of a g-line with respect to a d-line.

Incidentally, in order to better achieve an effect of the above-described conditional expression (6), it is more desirable that the numerical range of the conditional expression (6) be set as expressed by conditional expression (6)′ as follows. Satisfying the conditional expression (6)′ makes it possible to achieve a telescopic lens having higher image-forming performance.

ΘgFn>0.6 (6)′

Further, it is desirable that the imaging lens according to the present embodiment satisfy the following conditional expression (7):

20<νdL11<69 (7)
where
νdL11 is the Abbe number of the first lens L11.

The conditional expression (7) is an expression that defines Abbe number of the glass material of the first lens L11. Falling below and exceeding the conditional expression (7) both make it difficult to correct a chromatic aberration, especially an on-axis chromatic aberration.

Incidentally, in order to better achieve an effect of the above-described conditional expression (7), it is more desirable that the numerical range of the conditional expression (7) be set as expressed by conditional expression (7)′ as follows. Satisfying the conditional expression (7)′ makes it possible to achieve a telescopic lens having higher image-forming performance.

25<νdL11<69 (7)′

Further, it is desirable that the imaging lens according to the present embodiment satisfy the following conditional expression (8):

0.45<φL12/φL11<0.88 (8)
where
φL11 is an effective lens diameter of the first lens L11, and
φL12 is an effective lens diameter of the second lens L12.

The conditional expression (8) is an expression in which the effective lens diameter of the second lens L12 is normalized with respect to the effective lens diameter of the first lens L11. Falling below the conditional expression (8) makes the power of the first lens L11 excessively strong, leading to a deterioration in the aberration, especially the spherical aberration, generated in the first lens L11. Exceeding the conditional expression (8) leads to an excessive increase in the lens diameter of the second lens L12, causing a weight to be heavy.

Incidentally, in order to better achieve an effect of the above-described conditional expression (8), it is more desirable that the numerical range of the conditional expression (8) be set as expressed by conditional expression (8)′ as follows. Satisfying the conditional expression (8)′ makes it possible to achieve a telescopic lens that is lighter in weight and that has higher image-forming performance.

0.50<φL12/φL11<0.83 (8)′

Further, in the imaging lens according to the present embodiment, it is desirable that the plurality of optical elements within the first lens group GR1 further include a lens L10 that is disposed closest to the object side and that satisfies the following conditional expression (9):

−0.3<f/fL10<0.3 (9)
where
fL10 is a focal distance, in a d-line, of the above-described lens L10 disposed closest to the object side.

The conditional expression (9) is an expression that defines the focal distance of the lens L10 with respect to a focal distance of the lens system as a whole. The imaging lens according to the present embodiment may dispose the lens L10 that satisfies the conditional expression (9) at a position closest to the object side. Satisfying the conditional expression (9) allows the lens L10 to be a lens that does not have power substantially (that has a weak power). This makes it possible for such a lens L10 that does not have the power substantially to have a function as a protective filter by disposing the lens L10 at the position closest to the object side. In this case, it is possible to prevent generation of a ghost caused by a reflection between surfaces of lens(es) by allowing the lens L10 to have the weak power appropriately. Falling below or exceeding the conditional expression (9) makes the power of the lens L10 excessively strong, leading to a deterioration in an aberration, especially a spherical aberration, generated in the lens L10.

Incidentally, in order to better achieve an effect of the above-described conditional expression (9), it is more desirable that the numerical range of the conditional expression (9) be set as expressed by conditional expression (9)′ as follows. Satisfying the conditional expression (9)′ makes it possible to achieve a telescopic lens that is lighter in weight and that has higher image-forming performance.

−0.26<f/fL10<0.26 (9)′

### 3. Example of Application to Imaging Apparatus

Next, description is given of an example of application, to an imaging apparatus, of the imaging lens according to the present embodiment.

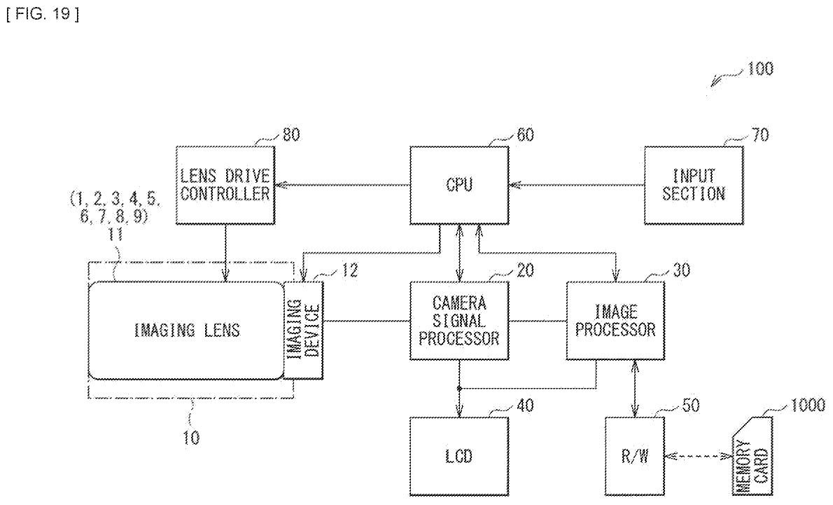

FIG. 19 illustrates a configuration example of an imaging apparatus 100 to which the imaging lens according to the present embodiment is applied. The imaging apparatus 100 is, for example, a digital still camera, and includes a camera block 10, a camera signal processor 20, an image processor 30, LCD (Liquid Crystal Display) 40, R/W (reader/writer) 50, CPU (Central Processing Unit) 60, an input section 70, and a lens drive controller 80.

The camera block 10 takes a role in an imaging function, and includes: an optical system including an imaging lens 11; and an imaging device 12 such as CCD (Charge Coupled Devices) or CMOS (Complementary Metal Oxide Semiconductor). The imaging device 12 converts an optical image formed by the imaging lens 11 into an electric signal, to thereby output an imaging signal (an image signal) that corresponds to the optical image. Any of the imaging lenses 1 to 9 of the respective configuration examples illustrated in FIG. 1 to FIG. 9 is applicable as the imaging lens 11.

The camera signal processor 20 performs, on the image signal outputted from the imaging device 12, various kinds of signal processes including, for example, an analog-digital conversion, a noise removal, an image quality correction, or a conversion to luminance and color difference signals.

The image processor 30 performs processes of recording and reproduction of an image signal. The image processor 30 performs processes including, for example, compression coding and expansion decoding processes of an image signal based on a predetermined image data format, and a process of converting data specification such as resolution.

The LCD 40 has a function of displaying various pieces of data including, for example, a state of operation performed on the input section 70 by a user and a photographed image. The R/W 50 performs writing of image data encoded by the image processor 30 into a memory card 1000, and reading of the image data recorded in the memory card 1000. The memory card 1000 is a semiconductor memory attachable to and detachable from a slot coupled to the R/W 50, for example.

The CPU 60 functions as a control processor that controls each circuit block provided in the imaging apparatus 100. The CPU 60 controls each of the circuit blocks on the basis of, for example, an instruction input signal from the input section 70. The input section 70 includes, for example, various switches on which necessary operations are performed by the user. For example, the input section 70 includes a shutter release button used to perform a shutter operation, a selection switch used to select an operation mode, etc. The input section 70 outputs, to the CPU 60, the instruction input signal that corresponds to the operation performed by the user. The lens drive controller 80 controls driving of lenses disposed in the camera block 10. The lens drive controller 80 controls, for example, unillustrated motors that drive respective lenses of the imaging lens 11 on the basis of a control signal from the CPU 60.

In the following, description is given of operations in the imaging apparatus 100.

In a standby state upon photographing, an image signal photographed in the camera block 10 is outputted to the LCD 40 through the camera signal processor 20 and is thus displayed as a camera-through image, under control of the CPU 60. Further, for example, when the instruction input signal, for focusing, from the input section 70 is inputted, the CPU 60 outputs the control signal to the lens drive controller 80. This causes a predetermined lens of the imaging lens 11 to travel on the basis of control performed by the lens drive controller 80.

When an unillustrated shutter of the camera block 10 is operated in response to the instruction input signal from the input section 70, the photographed image signal is outputted from the camera signal processor 20 to the image processor 30. The photographed image signal outputted to the image processor 30 is subjected to the compression coding process and is thus converted into digital data in a predetermined data format. The converted data is outputted to the R/W 50 to be written into the memory card 1000.

It is to be noted that the focusing is performed in a case where the shutter release button of the input section 70 is pressed halfway, or in a case where the shutter release button is pressed fully for recording (photographing), for example. The focusing is performed by causing a predetermined lens of the imaging lens 11 to travel by the lens drive controller 80 on the basis of the control signal from the CPU 60.

In a case where the image data recorded in the memory card 1000 is to be reproduced, predetermined image data is read from the memory card 1000 by the R/W 50 in accordance with the operation performed on the input section 70. The predetermined image data read from the memory card 1000 is subjected to the expansion decoding process by the image processor 30. Thereafter, a reproduction image signal is outputted to the LCD 40 and a reproduced image is thus displayed.

It is to be noted that, although the above-described embodiment illustrates an example in which the imaging apparatus is applied to the digital still camera, etc., a range of application of the imaging apparatus is not limited to the digital still camera. The imaging apparatus is applicable to other various imaging apparatuses. For example, the imaging apparatus is applicable to a digital single-lens reflex camera, a digital non-reflex camera, a digital video camera, a surveillance camera, etc. Further, the imaging apparatus is applicable widely to, for example, a camera section of a digital input-output device such as a mobile phone mounted with a camera or an information terminal mounted with a camera. In addition, the imaging apparatus is applicable to an interchangeable-lens camera as well.

### Working Examples

### 4. Numerical Working Examples of Lenses

Next, description is given of specific Numerical Working Examples of the imaging lens according to the present embodiment. Here, the description is given of Numerical Working Examples in which specific numerical values are applied to the imaging lenses 1 to 9 of the respective configuration examples illustrated in FIG. 1 to FIG. 9.

It is to be noted that meanings, etc. of respective symbols indicated in the following tables and descriptions are as follows. “Surface No.” denotes number of i-th surface counting from the object side to the image plane side. “Ri” denotes a value (mm) of a paraxial radius of curvature of the i-th surface. “Di” denotes a value (mm) of an interval on the optical axis between the i-th surface and (i+1)th surface. “ndi” denotes a value of refractive index in a d-line (wavelength of 587.6 nm) of a material of an optical component that has the i-th surface. “vdi” denotes a value of Abbe number in the d-line of the material of the optical component that has the i-th surface. A portion where the value of “Ri” is “∞” indicates a flat surface or an aperture stop surface (an aperture stop St). A surface denoted as “ASP” is an aspherical surface. A surface denoted as “STO” is the aperture stop St. “f” denotes a focal distance of an optical system as a whole upon the infinity focusing, “Fno” denotes an F number, and “w” denotes a half angle of view. “β” denotes magnification upon focusing.

It is to be noted that Abbe number and a partial dispersion ratio of a lens material used for each of the imaging lenses according to the present Working Examples are as follows. Refractive indices with respect to a g-line (wavelength of 435.8 nm), a F-line (wavelength of 486.1 nm), a d-line (wavelength of 587.6 nm), and a C-line (wavelength of 656.3 nm) of the Fraunhofer lines are respectively defined as Ng, NF, Nd, and NC. Abbe number and a partial dispersion ratio ΘgF in relation to the g-line and to the F-line are as follows.

νd=(Nd−1)/(NF−NC)

ΘgF=(Ng−NF)/(NF−NC)

In each of the Numerical Working Examples, an aspherical surface shape is defined by the following aspherical surface expression. It is to be noted that, in each of the tables that indicates aspherical coefficients to be described later, a multiplicator including a base of 10 with an exponent is represented using “E”. For example, “1.2×10⁻⁰²” is represented as “1.2E-02”.

(Aspherical Surface Expression)

x=c²y²/[1+{1−(1+K)c²y²}^{1/2}]+ΣAi·yⁱ

where

x is distance in the optical axis direction from an apex of a lens surface,
Y is a height in a direction perpendicular to the optical axis,
c is a paraxial curvature at an apex of a lens (inverse of a paraxial radius of curvature),
K is a Conic constant, and
Ai is an i-th order aspherical coefficient.

### Configuration Common to Each Numerical Working Example

### Numerical Working Examples 1 to 5

The imaging lenses 1 to 5 to which the following respective Numerical Working Examples 1 to 5 are applied each have a configuration that satisfies the above-described first basic configuration. That is, the imaging lenses 1 to 5 each have the configuration in which the first lens group GR1 having the positive refractive power and including the plurality of optical elements, the second lens group GR2 having the positive refractive power, and the third lens group GR3 having the negative refractive power are disposed in order from the object side toward the image plane side.

In each of the imaging lenses 1 to 5, the second lens group GR2 travels on the optical axis to the object side upon the focusing from the object at the infinity to the object at the short distance. The plurality of optical elements within the first lens group GR1 include, in order from the object side toward the image plane side, at least the first lens L11 having the positive refractive power and the second lens L12.

### Numerical Working Examples 6 to 9

The imaging lenses 6 to 9 to which the following respective Numerical Working Examples 6 to 9 are applied each have a configuration that satisfies the above-described second basic configuration. That is, the imaging lenses 6 to 9 each have the configuration in which the first lens group GR1 having the positive refractive power and including the plurality of optical elements, the second lens group GR2 having the negative refractive power, and the third lens group GR3 having the positive refractive power are disposed in order from the object side toward the image plane side.

In each of the imaging lenses 6 to 9, the second lens group GR2 travels on the optical axis to the image plane side upon the focusing from the object at the infinity to the object at the short distance. The plurality of optical elements within the first lens group GR1 include, in order from the object side toward the image plane side, at least the first lens L11 having the positive refractive power and the second lens L12.

### Numerical Working Example 1

[Table 1] illustrates basic lens data of Numerical Working Example 1 in which specific numerical values are applied to the imaging lens 1 illustrated in FIG. 1. Further, [Table 2] illustrates a value of the focal distance f of the optical system as a whole upon the infinity focusing, a value of the F number (Fno), and a value of the half angle of view w.

Further, [Table 3] illustrates a value of a variable surface interval. In the Numerical Working Example 1, values of respective surface intervals D14 and D17 vary upon the focusing. Further, for reference, D35 in [Table 3] indicates a value of backfocus.

Further, [Table 4] illustrates a starting surface of a lens surface of each of the groups, and a value of the focal distance of each of the groups.

In the imaging lens 1 according to the Numerical Working Example 1, the first lens group GR1 includes, in order from the object side toward the image plane side, a positive first lens (the first lens L11), a positive second lens (the second lens L12), a negative third lens (a lens L13), a positive fourth lens (a lens L14), a positive fifth lens (a lens L15), a lens in which a negative sixth lens (a lens L16) and a positive seventh lens (a lens L17) are attached together, and the aperture stop St.

The second lens group GR2 includes a cemented lens in which a positive eighth lens (a lens L21) and a negative ninth lens (a lens L22) are attached together, in order from the object side toward the image plane side.

The third lens group GR3 includes, in order from the object side toward the image plane side, a cemented lens in which a positive tenth lens (a lens L31) and a negative eleventh lens (a lens L32) are attached together, a positive twelfth lens (a lens L33), a negative thirteenth lens (a lens L34), a negative fourteenth lens (a lens L35), a positive fifteenth lens (a lens L36), a cemented lens in which a positive sixteenth lens (a lens L37) and a negative seventeenth lens (a lens L38) are attached together, a positive eighteenth lens (a lens L39), and a negative nineteenth lens (a lens L40).

It is to be noted that, in the imaging lens 1 according to the Numerical Working Example 1, the positive twelfth lens, the negative thirteenth lens, and the negative fourteenth lens may be caused to travel in a direction perpendicular to the optical axis Z1 to thereby perform an image stabilization, upon generation of camera shake. Alternatively, the positive twelfth lens and the negative thirteenth lens may be caused to travel in the direction perpendicular to the optical axis Z1 to thereby perform the image stabilization.

TABLE 1
Working Example 1

| Surface No. | Ri | Di | ndi | νdi |
|---|---|---|---|---|
| 1 | 327.6228 | 11.89 | 1.59349 | 67 |
| 2 | −1436.5 | 158.5 | | |
| 3 | 99.16411 | 20 | 1.43699 | 95 |
| 4 | 2206.367 | 3.293 | | |
| 5 | −274.15 | 3.5 | 1.80517 | 25.4 |
| 6 | 454.9194 | 0.5 | | |
| 7 | 72.08155 | 14.75 | 1.43699 | 95 |
| 8 | −1147.5 | 1.736 | | |
| 9 | 369.3451 | 3.5 | 1.73799 | 32.2 |
| 10 | 769.6199 | 1.569 | | |
| 11 | 353.657 | 3 | 1.78589 | 43.9 |
| 12 | 45.32487 | 11.75 | 1.43699 | 95 |
| 13 | 1100.663 | 3.317 | | |
| 14 (STO) | ∞ | (D14) | | |
| 15 | 80.31099 | 7.02 | 1.59269 | 35.4 |
| 16 | −189.467 | 1.5 | 1.91081 | 35.2 |
| 17 | −861.307 | (D17) | | |
| 18 | 203.5595 | 3.666 | 1.89285 | 20.3 |
| 19 | −106.289 | 1.3 | 1.91081 | 35.2 |
| 20 | 48.0264 | 5.427 | | |
| 21 | 905.1303 | 6 | 1.80517 | 25.4 |
| 22 | −51.8885 | 0 | | |
| 23 | −51.9588 | 2.52 | 1.78589 | 43.9 |
| 24 | 116.1934 | 6.207 | | |
| 25 | −208.636 | 1.542 | 1.72915 | 54.6 |
| 26 | 204.7046 | 2 | | |
| 27 | 76.19549 | 6 | 1.69894 | 30 |
| 28 | −523.384 | 48.12 | | |
| 29 | 133.1271 | 12 | 1.69894 | 30 |
| 30 | −40.208 | 3 | 1.92285 | 20.8 |
| 31 | 177.7478 | 0.5 | | |
| 32 | 77.60341 | 7.015 | 1.80517 | 25.4 |
| 33 | −95.1349 | 21.84 | | |
| 34 | −55.3319 | 2.548 | 1.92285 | 20.8 |
| 35 | 336.1427 | (D35) | | |

TABLE 2
Working Example 1

| | |
|---|---|
| f | 388.01 |
| Fno | 2.88 |
| ω | 3.11 |

TABLE 3
Working Example 1

| | | | |
|---|---|---|---|
| β | 0 | 0.033 | 0.154 |
| D14 | 17.972 | 14.166 | 1.5 |
| D17 | 2 | 5.806 | 18.472 |
| D35 | 15.508 | 15.508 | 15.508 |

TABLE 4
Working Example 1

| | Starting | Focal |
|---|---|---|
| | Surface | Distance |
| GR1 | 1 | 265.09 |
| GR2 | 15 | 147.624 |
| GR3 | 18 | −42.589 |

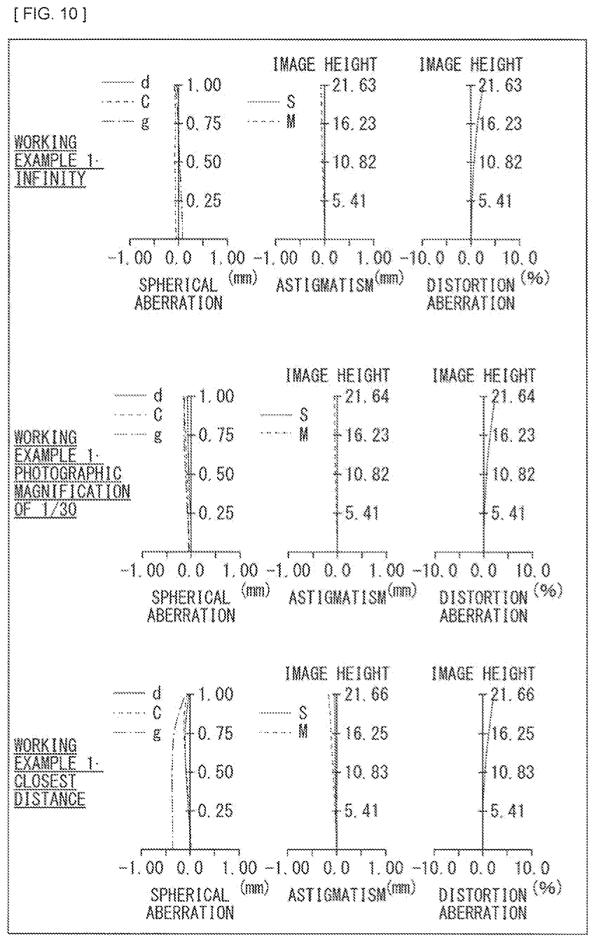

The top of FIG. 10 illustrates a longitudinal aberration upon the infinity focusing in the Numerical Working Example 1. The middle of FIG. 10 illustrates a longitudinal aberration upon focusing at a photographic magnification of 1/30 in the Numerical Working Example 1. The bottom of FIG. 10 illustrates a longitudinal aberration upon closest-distance focusing in the Numerical Working Example 1. As the longitudinal aberration, FIG. 10 illustrates a spherical aberration, astigmatism (a field curvature), and a distortion aberration. In the astigmatism diagrams, a solid line (S) indicates a value in a sagittal image plane and a broken line (M) indicates a value in a meridional image plane. Each of the aberration diagrams indicates values in the d-line. The spherical aberration diagrams also indicate values of the C-line (the wavelength of 656.3 nm) and the g-line (the wavelength of 435.8 nm). These apply similarly to aberration diagrams in subsequent other Numeral Working Examples.

As can be appreciated from each of the aberration diagrams, each of the aberrations are favorably corrected in a balanced fashion upon the infinity focusing, upon the focusing at the photographic magnification of 1/30, and upon the closest-distance focusing in the imaging lens 1 according to the Numerical Working Example 1. Hence, it is clear that the imaging lens 1 according to the Numerical Working Example 1 has small performance variation upon focusing and superior image-forming performance.

### Numerical Working Example 2

[Table 5] illustrates basic lens data of Numerical Working Example 2 in which specific numerical values are applied to the imaging lens 2 illustrated in FIG. 2. Further, [Table 6] illustrates a value of the focal distance f of the optical system as a whole upon the infinity focusing, a value of the F number (Fno), and a value of the half angle of view ω.

Further, [Table 7] illustrates a value of a variable surface interval. In the Numerical Working Example 2, values of the respective surface intervals D14 and D17 vary upon the focusing. Further, for reference, D35 in [Table 7] indicates a value of backfocus.

Further, [Table 8] illustrates a starting surface of a lens surface of each of the groups, and a value of the focal distance of each of the groups.

In the imaging lens 2 according to the Numerical Working Example 2, the first lens group GR1 includes, in order from the object side toward the image plane side, the positive first lens (the first lens L11), the positive second lens (the second lens L12), the negative third lens (the lens L13), the positive fourth lens (the lens L14), the negative fifth lens (the lens L15), the lens in which the negative sixth lens (the lens L16) and the positive seventh lens (the lens L17) are attached together, and the aperture stop St.

The second lens group GR2 includes the cemented lens in which the positive eighth lens (the lens L21) and the negative ninth lens (the lens L22) are attached together, in order from the object side toward the image plane side.

The third lens group GR3 includes, in order from the object side toward the image plane side, the cemented lens in which the positive tenth lens (the lens L31) and the negative eleventh lens (the lens L32) are attached together, the positive twelfth lens (the lens L33), the negative thirteenth lens (the lens L34), the negative fourteenth lens (the lens L35), the positive fifteenth lens (the lens L36), the cemented lens in which the positive sixteenth lens (the lens L37) and the negative seventeenth lens (the lens L38) are attached together, the positive eighteenth lens (the lens L39), and the negative nineteenth lens (the lens L40).

It is to be noted that, in the imaging lens 2 according to the Numerical Working Example 2, the positive twelfth lens, the negative thirteenth lens, and the negative fourteenth lens may be caused to travel in the direction perpendicular to the optical axis Z1 to thereby perform the image stabilization, upon the generation of camera shake. Alternatively, the positive twelfth lens and the negative thirteenth lens may be caused to travel in the direction perpendicular to the optical axis Z1 to thereby perform the image stabilization.

TABLE 5
Working Example 2

| Surface No. | Ri | Di | ndi | νdi |
|---|---|---|---|---|
| 1 | 211.9904 | 13.36 | 1.59349 | 67 |
| 2 | 4921.029 | 155.2 | | |
| 3 | 139.0942 | 8.145 | 1.43699 | 95 |
| 4 | −550.702 | 2.342 | | |
| 5 | −190.19 | 2.7 | 1.85894 | 22.7 |
| 6 | −924.726 | 0.2 | | |
| 7 | 78.35142 | 12.37 | 1.43699 | 95 |
| 8 | −268.598 | 0.2 | | |
| 9 | −748.755 | 2.5 | 1.73799 | 32.2 |
| 10 | 3694.964 | 3.002 | | |
| 11 | 34145.75 | 2.2 | 1.78589 | 43.9 |
| 12 | 52.92771 | 9.266 | 1.43699 | 95 |
| 13 | 285.3604 | 5.572 | | |
| 14 (STO) | ∞ | (D14) | | |
| 15 | 84.47801 | 7.807 | 1.59269 | 35.4 |
| 16 | −109.806 | 9.5 | 1.91081 | 35.2 |
| 17 | −216.18 | (D17) | | |
| 18 | 103.2879 | 2.807 | 1.89285 | 20.3 |
| 19 | −1070.78 | 1.3 | 1.91081 | 35.2 |
| 20 | 43.11681 | 6.788 | | |
| 21 | 256.6919 | 6 | 1.80517 | 25.4 |
| 22 | −59.2547 | 0 | | |
| 23 | −59.413 | 1.3 | 1.78589 | 43.9 |
| 24 | 101.7878 | 3.589 | | |
| 25 | −194.2 | 1.3 | 1.72915 | 54.6 |
| 26 | 148.2123 | 2 | | |
| 27 | 66.6035 | 6 | 1.69894 | 30 |
| 28 | 463.1509 | 43.11 | | |
| 29 | 90.65593 | 12 | 1.69894 | 30 |
| 30 | −44.8182 | 1.5 | 1.92285 | 20.8 |
| 31 | 115.6354 | 0.2 | | |
| 32 | 72.3228 | 7.022 | 1.80517 | 25.4 |
| 33 | −110.873 | 29.89 | | |
| 34 | −50.1378 | 1.714 | 1.92285 | 20.8 |
| 35 | 10992.2 | (D35) | | |

TABLE 6
Working Example 2

| | |
|---|---|
| f | 388.00 |
| Fno | 2.88 |
| ω | 3.13 |

TABLE 7
Working Example 2

| | | | |
|---|---|---|---|
| β | 0 | 0.033 | 0.154 |
| D14 | 24.099 | 20.148 | 6.853 |
| D17 | 2 | 5.951 | 19.246 |
| D35 | 15.508 | 15.508 | 15.508 |

TABLE 8
Working Example 2

| | Starting | Focal |
|---|---|---|
| | Surface | Distance |
| GR1 | 1 | 381.847 |
| GR2 | 15 | 121.973 |
| GR3 | 18 | −46.965 |

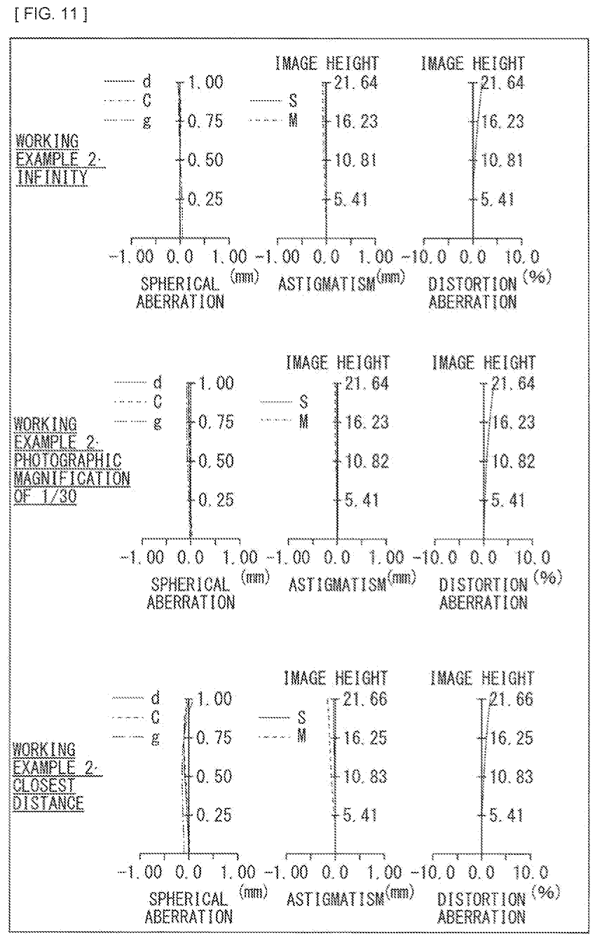

The top of FIG. 11 illustrates a longitudinal aberration upon the infinity focusing in the Numerical Working Example 2. The middle of FIG. 11 illustrates a longitudinal aberration upon the focusing at the photographic magnification of 1/30 in the Numerical Working Example 2. The bottom of FIG. 11 illustrates a longitudinal aberration upon the closest-distance focusing in the Numerical Working Example 2. [0106] As can be appreciated from each of the aberration diagrams, each of the aberrations are favorably corrected in a balanced fashion upon the infinity focusing, upon the focusing at the photographic magnification of 1/30, and upon the closest-distance focusing in the imaging lens 2 according to the Numerical Working Example 2. Hence, it is clear that the imaging lens 2 according to the Numerical Working Example 2 has small performance variation upon focusing and superior image-forming performance.

### Numerical Working Example 3

[Table 9] illustrates basic lens data of Numerical Working Example 3 in which specific numerical values are applied to the imaging lens 3 illustrated in FIG. 3. Further, [Table 10] illustrates a value of the focal distance f of the optical system as a whole upon the infinity focusing, a value of the F number (Fno), and a value of the half angle of view w.

Further, [Table 11] illustrates a value of a variable surface interval. In the Numerical Working Example 3, values of the respective surface intervals D14 and D17 vary upon the focusing. Further, for reference, D35 in [Table 11] indicates a value of backfocus.

Further, [Table 12] illustrates a starting surface of a lens surface of each of the groups, and a value of the focal distance of each of the groups.

In the imaging lens 3 according to the Numerical Working Example 3, the first lens group GR1 includes, in order from the object side toward the image plane side, the positive first lens (the first lens L11), the positive second lens (the second lens L12), the negative third lens (the lens L13), the positive fourth lens (the lens L14), the fifth lens (the lens L15), the lens in which the negative sixth lens (the lens L16) and the positive seventh lens (the lens L17) are attached together, and the aperture stop St.

The second lens group GR2 includes the cemented lens in which the positive eighth lens (the lens L21) and the negative ninth lens (the lens L22) are attached together, in order from the object side toward the image plane side.

The third lens group GR3 includes, in order from the object side toward the image plane side, the cemented lens in which the positive tenth lens (the lens L31) and the negative eleventh lens (the lens L32) are attached together, the positive twelfth lens (the lens L33), the negative thirteenth lens (the lens L34), the negative fourteenth lens (the lens L35), the positive fifteenth lens (the lens L36), the cemented lens in which the positive sixteenth lens (the lens L37) and the negative seventeenth lens (the lens L38) are attached together, the positive eighteenth lens (the lens L39), and the negative nineteenth lens (the lens L40).

It is to be noted that, in the imaging lens 3 according to the Numerical Working Example 3, the positive twelfth lens, the negative thirteenth lens, and the negative fourteenth lens may be caused to travel in the direction perpendicular to the optical axis Z1 to thereby perform the image stabilization, upon the generation of camera shake. Alternatively, the positive twelfth lens and the negative thirteenth lens may be caused to travel in the direction perpendicular to the optical axis Z1 to thereby perform the image stabilization.

TABLE 9
Working Example 3

| Surface No. | Ri | Di | ndi | νdi |
|---|---|---|---|---|
| 1 | 272.8043 | 12.41 | 1.7521 | 25 |
| 2 | 14363.89 | 81.58 | | |
| 3 | 198.4476 | 20 | 1.43699 | 95 |
| 4 | −244.803 | 0.811 | | |
| 5 | −215.282 | 5.889 | 1.85894 | 22.7 |
| 6 | −575.662 | 4.19 | | |
| 7 | 121.9901 | 19.93 | 1.43699 | 95 |
| 8 | −208.931 | 4.669 | | |
| 9 | −104.536 | 5.5 | 1.73799 | 32.2 |
| 10 | −105.794 | 1.929 | | |
| 11 | −288.101 | 4.685 | 1.80517 | 25.4 |
| 12 | 68.35966 | 13.95 | 1.43699 | 95 |
| 13 | 223.8009 | 33.48 | | |
| 14 (STO) | ∞ | (D14) | | |
| 15 | 100.3239 | 8.268 | 1.68892 | 31.1 |
| 16 | −112.052 | 3 | 1.85134 | 40.1 |
| 17 | −342.478 | (D17) | | |
| 18 | 103.1117 | 3.07 | 1.84665 | 23.8 |
| 19 | 274.3342 | 2 | 1.88099 | 40.1 |
| 20 | 46.87717 | 6.636 | | |
| 21 | −2037.39 | 5.822 | 1.80517 | 25.4 |
| 22 | −63.2871 | 0 | | |
| 23 | −63.8888 | 2.614 | 1.80419 | 46.5 |
| 24 | 115.9806 | 1.873 | | |
| 25 | −17646.5 | 1.837 | 1.8061 | 40.7 |
| 26 | 278.9415 | 2.143 | | |
| 27 | 53.26785 | 6 | 1.69894 | 30 |
| 28 | 248.8407 | 40.26 | | |
| 29 | 1023.737 | 12.5 | 1.69894 | 30 |
| 30 | −34.1864 | 2.106 | 1.92285 | 20.8 |
| 31 | −553.08 | 1 | | |
| 32 | 101.9084 | 7 | 1.94593 | 17.9 |
| 33 | −980.552 | 31.29 | | |
| 34 | −76.8244 | 2 | 1.92285 | 20.8 |
| 35 | 4156.65 | (D35) | | |

TABLE 10
Working Example 3

| | |
|---|---|
| f | 388.00 |
| Fno | 2.88 |
| ω | 3.13 |

TABLE 11
Working Example 3

| | | | |
|---|---|---|---|
| β | 0 | 0.033 | 0.158 |
| D14 | 20.769 | 16.603 | 2 |
| D17 | 2 | 6.167 | 20.769 |
| D35 | 15.508 | 15.508 | 15.508 |

TABLE 12
Working Example 3

| | Starting | Focal |
|---|---|---|
| | Surface | Distance |
| GR1 | 1 | 443.005 |
| GR2 | 15 | 127.445 |
| GR3 | 18 | −53.335 |

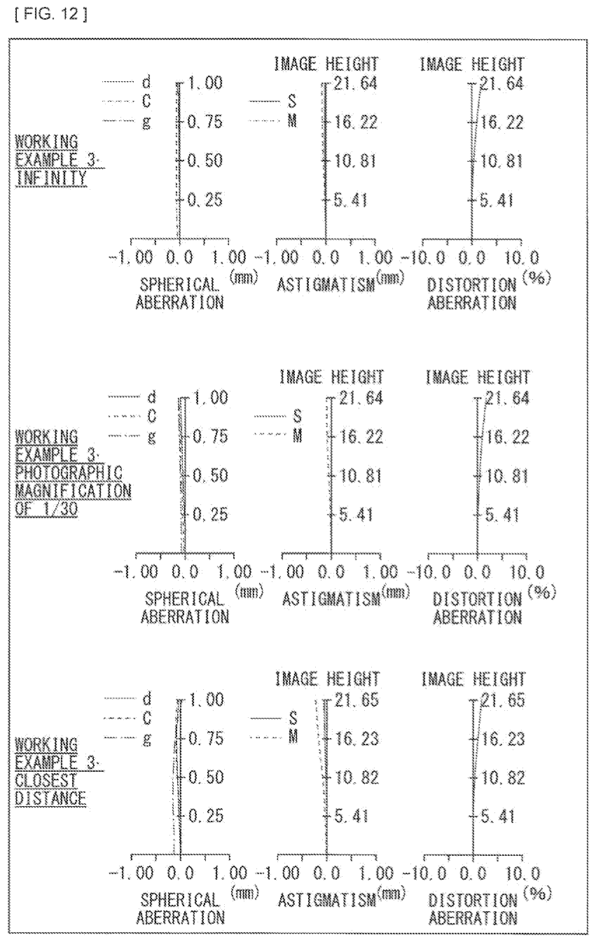

The top of FIG. 12 illustrates a longitudinal aberration upon the infinity focusing in the Numerical Working Example 3. The middle of FIG. 12 illustrates a longitudinal aberration upon the focusing at the photographic magnification of 1/30 in the Numerical Working Example 3. The bottom of FIG. 12 illustrates a longitudinal aberration upon the closest-distance focusing in the Numerical Working Example 3.

As can be appreciated from each of the aberration diagrams, each of the aberrations are favorably corrected in a balanced fashion upon the infinity focusing, upon the focusing at the photographic magnification of 1/30, and upon the closest-distance focusing in the imaging lens 3 according to the Numerical Working Example 3. Hence, it is clear that the imaging lens 3 according to the Numerical Working Example 3 has small performance variation upon focusing and superior image-forming performance.

### Numerical Working Example 4

[Table 13] illustrates basic lens data of Numerical Working Example 4 in which specific numerical values are applied to the imaging lens 4 illustrated in FIG. 4. Further, [Table 14] illustrates a value of the focal distance f of the optical system as a whole upon the infinity focusing, a value of the F number (Fno), and a value of the half angle of view w.

Further, [Table 15] illustrates a value of a variable surface interval. In the Numerical Working Example 4, values of the respective surface intervals D14 and D17 vary upon the focusing. Further, for reference, D34 in [Table 15] indicates a value of backfocus.

Further, [Table 16] illustrates a starting surface of a lens surface of each of the groups, and a value of the focal distance of each of the groups.

In the imaging lens 4 according to the Numerical Working Example 4, the first lens group GR1 includes, in order from the object side toward the image plane side, a protective filter glass (the lens L10) having extremely-weak negative power, the positive first lens (the first lens L11), the positive second lens (the second lens L12), the negative third lens (the lens L13), the positive fourth lens (the lens L14), a lens in which the negative fifth lens (the lens L15) and the positive sixth lens (the lens L16) are attached together, and the aperture stop St.

The second lens group GR2 includes a cemented lens in which the positive seventh lens (the lens L21) and the negative eighth lens (the lens L22) are attached together, in order from the object side toward the image plane side.

The third lens group GR3 includes, in order from the object side toward the image plane side, the cemented lens in which the positive ninth lens (the lens L31) and the negative tenth lens (the lens L32) are attached together, the positive eleventh lens (the lens L33), the negative twelfth lens (the lens L34), the negative thirteenth lens (the lens L35), the positive fourteenth lens (the lens L36), a cemented lens in which the positive fifteenth lens (the lens L37) and the negative sixteenth lens (the lens L38) are attached together, the positive seventeenth lens (the lens L39), and the negative eighteenth lens (the lens L40).

It is to be noted that, in the imaging lens 4 according to the Numerical Working Example 4, the positive eleventh lens, the negative twelfth lens, and the negative thirteenth lens may be caused to travel in the direction perpendicular to the optical axis Z1 to thereby perform the image stabilization, upon the generation of camera shake. Alternatively, the positive eleventh lens and the negative twelfth lens may be caused to travel in the direction perpendicular to the optical axis Z1 to thereby perform the image stabilization.

TABLE 13
Working Example 4

| Surface No. | Ri | Di | ndi | νdi |
|---|---|---|---|---|
| 1 | 187.826 | 7 | 1.51679 | 64.1 |
| 2 | 156.1834 | 3 | | |
| 3 | 173.584 | 13.09 | 1.59269 | 35.3 |
| 4 | −3255.31 | 101.8 | | |
| 5 | 169.8493 | 8.949 | 1.43699 | 95 |
| 6 | −277.628 | 0.8 | | |
| 7 | −213.201 | 3.137 | 1.85894 | 22.7 |
| 8 | −3697.6 | 14.76 | | |
| 9 | 112.0579 | 9.729 | 1.43699 | 95 |
| 10 | −215.733 | 3.748 | | |
| 11 | −411.124 | 2.549 | 1.90365 | 31.3 |
| 12 | 71.71955 | 8.554 | 1.43699 | 95 |
| 13 | 295.7516 | 46.34 | | |
| 14 (STO) | ∞ | (D14) | | |
| 15 | 104.8227 | 7.555 | 1.62003 | 36.3 |
| 16 | −85.8072 | 3 | 1.80419 | 46.5 |
| 17 | −210.727 | (D17) | | |
| 18 | 67.35492 | 2.941 | 1.89285 | 20.3 |
| 19 | 114.743 | 1.4 | 1.91081 | 35.2 |
| 20 | 41.60055 | 18.66 | | |
| 21 | 126.036 | 4.778 | 1.80517 | 25.4 |
| 22 | −71.7777 | 1.3 | 1.74329 | 49.2 |
| 23 | 86.18455 | 4.641 | | |
| 24 | −133.379 | 1.3 | 1.83399 | 37.3 |
| 25 | 164.0739 | 2 | | |
| 26 | 47.86582 | 5.053 | 1.60341 | 38 |
| 27 | 340.4972 | 33.92 | | |
| 28 | 84.04808 | 7.247 | 1.7521 | 25 |
| 29 | −37.2919 | 2.017 | 1.92285 | 20.8 |
| 30 | 55.39262 | 6.424 | | |
| 31 | 67.53159 | 5.655 | 1.84665 | 23.7 |
| 32 | −218.371 | 62.61 | | |
| 33 | −62.1385 | 1.6 | 1.92285 | 20.8 |
| 34 | −447.23 | (D34) | | |

TABLE 14
Working Example 4

| | |
|---|---|
| f | 485.00 |
| Fno | 4.12 |
| ω | 2.50 |

TABLE 15
Working Example 4

| | | | |
|---|---|---|---|
| β | 0 | 0.033 | 0.14 |
| D14 | 26.353 | 22.196 | 9.471 |
| D17 | 2 | 6.156 | 18.882 |
| D34 | 15.508 | 15.508 | 15.508 |

TABLE 16
Working Example 4

| | Starting | Focal |
|---|---|---|
| | Surface | Distance |
| GR1 | 1 | 635.707 |
| GR2 | 15 | 133.07 |
| GR3 | 18 | −45.437 |

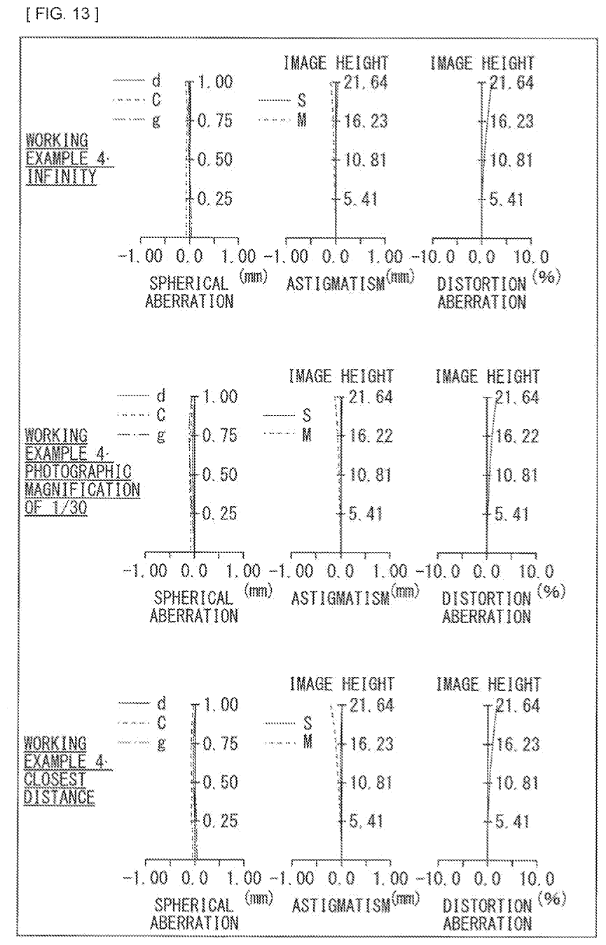

The top of FIG. 13 illustrates a longitudinal aberration upon the infinity focusing in the Numerical Working Example 4. The middle of FIG. 13 illustrates a longitudinal aberration upon the focusing at the photographic magnification of 1/30 in the Numerical Working Example 4. The bottom of FIG. 13 illustrates a longitudinal aberration upon the closest-distance focusing in the Numerical Working Example 4.

As can be appreciated from each of the aberration diagrams, each of the aberrations are favorably corrected in a balanced fashion upon the infinity focusing, upon the focusing at the photographic magnification of 1/30, and upon the closest-distance focusing in the imaging lens 4 according to the Numerical Working Example 4. Hence, it is clear that the imaging lens 4 according to the Numerical Working Example 4 has small performance variation upon focusing and superior image-forming performance.

### Numerical Working Example 5

[Table 17] illustrates basic lens data of Numerical Working Example 5 in which specific numerical values are applied to the imaging lens 5 illustrated in FIG. 5. Further, [Table 18] illustrates a value of the focal distance f of the optical system as a whole upon the infinity focusing, a value of the F number (Fno), and a value of the half angle of view w.

Further, [Table 19] illustrates a value of a variable surface interval. In the Numerical Working Example 5, values of the respective surface intervals D14 and D17 vary upon the focusing. Further, for reference, D34 in [Table 19] indicates a value of backfocus.

Further, [Table 20] illustrates a starting surface of a lens surface of each of the groups, and a value of the focal distance of each of the groups.

In the imaging lens 5 according to the Numerical Working Example 5, the first lens group GR1 includes, in order from the object side toward the image plane side, a protective filter glass (the lens L10) having extremely-weak positive power, the positive first lens (the first lens L11), the positive second lens (the second lens L12), the negative third lens (the lens L13), the positive fourth lens (the lens L14), the lens in which the negative fifth lens (the lens L15) and the positive sixth lens (the lens L16) are attached together, and the aperture stop St.

The second lens group GR2 includes the cemented lens in which the positive seventh lens (the lens L21) and the negative eighth lens (the lens L22) are attached together, in order from the object side toward the image plane side.

The third lens group GR3 includes, in order from the object side toward the image plane side, the cemented lens in which the positive ninth lens (the lens L31) and the negative tenth lens (the lens L32) are attached together, the positive eleventh lens (the lens L33), the negative twelfth lens (the lens L34), the negative thirteenth lens (the lens L35), the positive fourteenth lens (the lens L36), the cemented lens in which the positive fifteenth lens (the lens L37) and the negative sixteenth lens (the lens L38) are attached together, the positive seventeenth lens (the lens L39), and the negative eighteenth lens (the lens L40).

It is to be noted that, in the imaging lens 5 according to the Numerical Working Example 5, the positive eleventh lens, the negative twelfth lens, and the negative thirteenth lens may be caused to travel in the direction perpendicular to the optical axis Z1 to thereby perform the image stabilization, upon the generation of camera shake. Alternatively, the positive eleventh lens and the negative twelfth lens may be caused to travel in the direction perpendicular to the optical axis Z1 to thereby perform the image stabilization.

TABLE 17
Working Example 5

| Surface No. | Ri | Di | ndi | νdi |
|---|---|---|---|---|
| 1 | 241.752 | 6 | 1.51679 | 64.1 |
| 2 | 299.9725 | 3 | | |
| 3 | 274.5901 | 14.8 | 1.59269 | 35.3 |
| 4 | 5773.895 | 131.7 | | |
| 5 | 183.9828 | 10.96 | 1.43699 | 95 |
| 6 | −510.983 | 1.663 | | |
| 7 | −274.691 | 3.5 | 1.85894 | 22.7 |
| 8 | −1320.61 | 11.77 | | |
| 9 | 129.4403 | 10.86 | 1.43699 | 95 |
| 10 | −294.705 | 5.921 | | |
| 11 | −481.017 | 3.5 | 1.90365 | 31.3 |
| 12 | 85.36824 | 7.43 | 1.43699 | 95 |
| 13 | 541.9946 | 67.31 | | |
| 14 (STO) | ∞ | (D14) | | |
| 15 | 109.1433 | 6.655 | 1.59269 | 35.4 |
| 16 | −126.791 | 1.25 | 1.85134 | 40.1 |
| 17 | −301.486 | (D17) | | |
| 18 | 79.34144 | 3.487 | 1.89285 | 20.3 |
| 19 | 398.3852 | 1.4 | 1.91081 | 35.2 |
| 20 | 45.20562 | 14.87 | | |
| 21 | 106.6144 | 4.872 | 1.80517 | 25.4 |
| 22 | −97.5906 | 1.3 | 1.72915 | 54.6 |
| 23 | 80.55312 | 3.249 | | |
| 24 | −186.146 | 1.911 | 1.80609 | 33.2 |
| 25 | 148.6939 | 5.587 | | |
| 26 | 46.84863 | 6.3 | 1.59269 | 35.4 |
| 27 | 202.8453 | 32.85 | | |
| 28 | 112.779 | 7.758 | 1.7521 | 25 |
| 29 | −37.359 | 1.893 | 1.92285 | 20.8 |
| 30 | 44.3946 | 1.462 | | |
| 31 | 48.98801 | 5.6 | 1.80808 | 22.7 |
| 32 | −170.181 | 68.82 | | |
| 33 | −196.805 | 3.703 | 1.92285 | 20.8 |
| 34 | 164.7174 | (D34) | | |

TABLE 18
Working Example 5

| | |
|---|---|
| f | 582.00 |
| Fno | 4.12 |
| ω | 2.10 |

TABLE 19
Working Example 5

| | | | |
|---|---|---|---|
| β | 0 | 0.033 | 0.135 |
| D14 | 22.331 | 17.06 | 2 |
| D17 | 2 | 7.271 | 22.331 |
| D34 | 15.508 | 15.508 | 15.508 |

TABLE 20
Working Example 5

| | Starting | Focal |
|---|---|---|
| | Surface | Distance |
| GR1 | 1 | 571.519 |
| GR2 | 15 | 161.55 |
| GR3 | 18 | −46.833 |

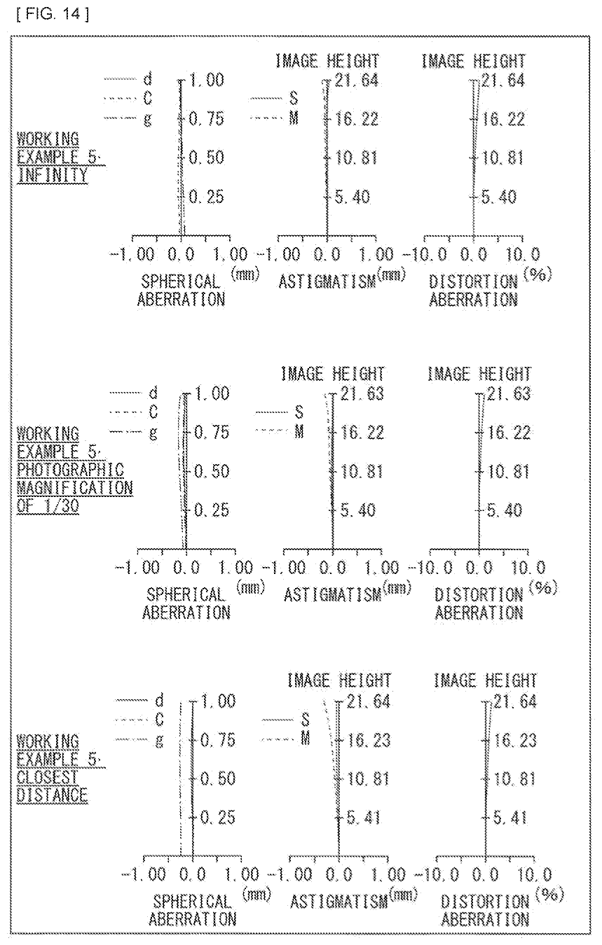

The top of FIG. 14 illustrates a longitudinal aberration upon the infinity focusing in the Numerical Working Example 5. The middle of FIG. 14 illustrates a longitudinal aberration upon the focusing at the photographic magnification of 1/30 in the Numerical Working Example 5. The bottom of FIG. 14 illustrates a longitudinal aberration upon the closest-distance focusing in the Numerical Working Example 5.

As can be appreciated from each of the aberration diagrams, each of the aberrations are favorably corrected in a balanced fashion upon the infinity focusing, upon the focusing at the photographic magnification of 1/30, and upon the closest-distance focusing in the imaging lens 5 according to the Numerical Working Example 5. Hence, it is clear that the imaging lens 5 according to the Numerical Working Example 5 has small performance variation upon focusing and superior image-forming performance.

### Numerical Working Example 6

[Table 21] illustrates basic lens data of Numerical Working Example 6 in which specific numerical values are applied to the imaging lens 6 illustrated in FIG. 6. Further, [Table 22] illustrates values of coefficients of aspherical surfaces. Further, [Table 23] illustrates a value of the focal distance f of the optical system as a whole upon the infinity focusing, a value of the F number (Fno), and a value of the half angle of view w.

Further, [Table 24] illustrates a value of a variable surface interval. In the Numerical Working Example 6, values of respective surface intervals D8 and D12 vary upon the focusing. Further, for reference, D28 in [Table 24] indicates a value of backfocus.

Further, [Table 25] illustrates a starting surface of a lens surface of each of the groups, and a value of the focal distance of each of the groups.

In the imaging lens 6 according to the Numerical Working Example 6, the first lens group GR1 includes, in order from the object side toward the image plane side, the positive first lens (the first lens L11), the positive second lens (the second lens L12), the negative third lens (the lens L13), and the positive fourth lens (the lens L14).

The second lens group GR2 includes, in order from the object side toward the image plane side, the positive fifth lens (the lens L21) and the negative sixth lens (the lens L22).

The third lens group GR3 includes, in order from the object side toward the image plane side, a lens in which the positive seventh lens (the lens L31) and the negative eighth lens (the lens L32) are attached together, the aperture stop St, a lens in which the positive ninth lens (the lens L33) and the negative tenth lens (the lens L34) are attached together, the negative eleventh lens (the lens L35), the positive twelfth lens (the lens L36), a lens in which the positive thirteenth lens (the lens L37) and the negative fourteenth lens (the lens L38) are attached together, and the negative fifteenth lens (the lens L39).

It is to be noted that, in the imaging lens 6 according to the Numerical Working Example 6, the lens in which the positive ninth lens and the negative tenth lens are attached together and the negative eleventh lens may be caused to travel in the direction perpendicular to the optical axis Z1 to thereby perform the image stabilization, upon the generation of camera shake.

TABLE 21
Working Example 6

| Surface No. | Ri | Di | ndi | νdi |
|---|---|---|---|---|
| 1 | 152.3823 | 10.95 | 1.5927 | 35.4 |
| 2 | 333.7856 | 81.48 | | |
| 3 (ASP) | 212.5904 | 17.92 | 1.437 | 95 |
| 4 (ASP) | −163.516 | 1 | | |
| 5 | −226.232 | 6 | 1.80808 | 22.7 |
| 6 | 8762.062 | 61.12 | | |
| 7 | 153.2905 | 17 | 1.437 | 95 |
| 8 | −278.308 | (D8) | | |
| 9 | 156.1397 | 5.892 | 2.10419 | 17 |
| 10 | −193.143 | 0.5 | | |
| 11 | −161.274 | 2.7 | 2.00069 | 25.4 |
| 12 (ASP) | 51.39049 | (D12) | | |
| 13 | 198.8545 | 12.21 | 1.70154 | 41.1 |
| 14 | −38.9001 | 3 | 1.84666 | 23.8 |
| 15 | −114.784 | 3 | | |
| 16 (STO) | ∞ | 3 | | |
| 17 | 88.74643 | 5.952 | 1.84666 | 23.7 |
| 18 | −99.884 | 1.8 | 1.7725 | 49.4 |
| 19 | 52.15204 | 4.01 | | |
| 20 | −390.457 | 1.6 | 1.881 | 40.1 |
| 21 | 82.59321 | 6.897 | | |
| 22 | 36.95355 | 10 | 1.58143 | 40.8 |
| 23 | 373.0697 | 21.13 | | |
| 24 | 60.96145 | 13.41 | 1.64768 | 33.8 |
| 25 | −27.0458 | 1.7 | 2.00069 | 25.4 |
| 26 | −115.742 | 9.422 | | |
| 27 | −2595.9 | 2.52 | 1.71699 | 47.9 |
| 28 | 44.38508 | (D28) | | |

TABLE 22
Working Example 6

| Surface No. | K | A4 | A6 |
|---|---|---|---|
| 3 | 0 | −9.347E−08 | 3.83E−12 |
| 4 | 0 | 4.6517E−08 | 1.465E−11 |
| 12 | −0.0185 | −1.5235E−07 | −2.6642E−10 |
| Surface No. | A8 | A10 | A12 |
| 3 | 5E−16 | 0 | 0 |
| 4 | −2.6E−15 | 0 | 0 |
| 12 | −1.171E−13 | 1.24E−16 | −2.9E−19 |

TABLE 23
Working Example 6

| | |
|---|---|
| f | 387.99 |
| Fno | 2.85 |
| ω | 3.13 |

TABLE 24
Working Example 6

| | | | |
|---|---|---|---|
| β | 0 | 0.033 | 0.164 |
| D8 | 17.565 | 20.609 | 33.334 |
| D12 | 46.829 | 43.785 | 31.06 |
| D28 | 30.506 | 30.506 | 30.506 |

TABLE 25
Working Example 6

| | Starting | Focal |
|---|---|---|
| | Surface | Distance |
| GR1 | 1 | 185.066 |
| GR2 | 9 | −82.263 |
| GR3 | 13 | 418.397 |

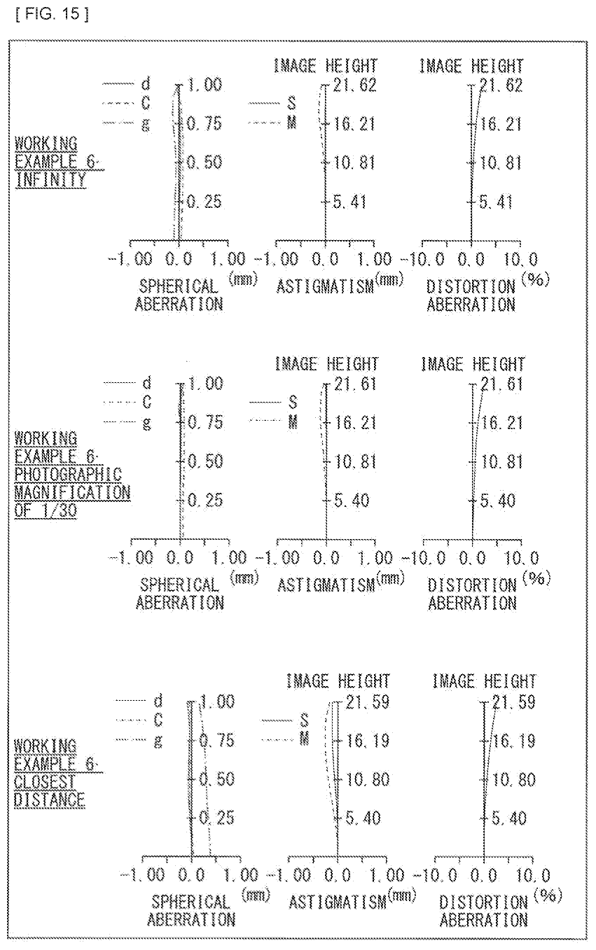

The top of FIG. 15 illustrates a longitudinal aberration upon the infinity focusing in the Numerical Working Example 6. The middle of FIG. 15 illustrates a longitudinal aberration upon the focusing at the photographic magnification of 1/30 in the Numerical Working Example 6. The bottom of FIG. 15 illustrates a longitudinal aberration upon the closest-distance focusing in the Numerical Working Example 6.

As can be appreciated from each of the aberration diagrams, each of the aberrations are favorably corrected in a balanced fashion upon the infinity focusing, upon the focusing at the photographic magnification of 1/30, and upon the closest-distance focusing in the imaging lens 6 according to the Numerical Working Example 6. Hence, it is clear that the imaging lens 6 according to the Numerical Working Example 6 has small performance variation upon focusing and superior image-forming performance.

### Numerical Working Example 7

[Table 26] illustrates basic lens data of Numerical Working Example 7 in which specific numerical values are applied to the imaging lens 7 illustrated in FIG. 7. Further, [Table 27] illustrates values of coefficients of aspherical surfaces. Further, [Table 28] illustrates a value of the focal distance f of the optical system as a whole upon the infinity focusing, a value of the F number (Fno), and a value of the half angle of view w.

Further, [Table 29] illustrates a value of a variable surface interval. In the Numerical Working Example 7, values of the respective surface intervals D8 and D12 vary upon the focusing. Further, for reference, D28 in [Table 29] indicates a value of backfocus.

Further, [Table 30] illustrates a starting surface of a lens surface of each of the groups, and a value of the focal distance of each of the groups.

In the imaging lens 7 according to the Numerical Working Example 7, the first lens group GR1 includes, in order from the object side toward the image plane side, the positive first lens (the first lens L11), the positive second lens (the second lens L12), the negative third lens (the lens L13), and the positive fourth lens (the lens L14).

The second lens group GR2 includes, in order from the object side toward the image plane side, the positive fifth lens (the lens L21) and the negative sixth lens (the lens L22).

The third lens group GR3 includes, in order from the object side toward the image plane side, the lens in which the positive seventh lens (the lens L31) and the negative eighth lens (the lens L32) are attached together, the aperture stop St, the lens in which the positive ninth lens (the lens L33) and the negative tenth lens (the lens L34) are attached together, the negative eleventh lens (the lens L35), the positive twelfth lens (the lens L36), the lens in which the positive thirteenth lens (the lens L37) and the negative fourteenth lens (the lens L38) are attached together, and the negative fifteenth lens (the lens L39).

It is to be noted that, in the imaging lens 7 according to the Numerical Working Example 7, the lens in which the positive ninth lens and the negative tenth lens are attached together and the negative eleventh lens may be caused to travel in the direction perpendicular to the optical axis Z1 to thereby perform the image stabilization, upon the generation of camera shake.

TABLE 26
Working Example 7

| Surface No. | Ri | Di | ndi | νdi |
|---|---|---|---|---|
| 1 | 152.6931 | 8.643 | 1.7521 | 25 |
| 2 | 249.938 | 97 | | |
| 3 (ASP) | 145.6878 | 19.81 | 1.437 | 95 |
| 4 (ASP) | −175.232 | 1 | | |
| 5 | −283.229 | 3.4 | 1.80518 | 25.4 |
| 6 | 297.4082 | 39.06 | | |
| 7 | 150.2893 | 19.15 | 1.437 | 95 |
| 8 | −255.114 | (D8) | | |
| 9 | 115.8723 | 3.095 | 2.10419 | 17 |
| 10 | 246.7598 | 0.728 | | |
| 11 | 440.5914 | 2.884 | 2.00069 | 25.4 |
| 12 (ASP) | 56.79784 | (D12) | | |
| 13 | 127.8648 | 11.19 | 1.70154 | 41.1 |
| 14 | −55.9836 | 3 | 1.84666 | 23.8 |
| 15 | −143.477 | 9.806 | | |
| 16 (STO) | ∞ | 3 | | |
| 17 | 67.41981 | 7.047 | 1.84666 | 23.7 |
| 18 | −89.6779 | 1.8 | 1.7725 | 49.4 |
| 19 | 38.94363 | 8.874 | | |
| 20 | −137.592 | 1.6 | 1.88202 | 37.2 |
| 21 | 63.58654 | 1.5 | | |
| 22 | 35.20713 | 12.84 | 1.58143 | 40.8 |
| 23 | −454.579 | 10.97 | | |
| 24 | 57.6567 | 15 | 1.64768 | 33.8 |
| 25 | −25.2521 | 2.989 | 2.00069 | 25.4 |
| 26 | −59.4675 | 0.797 | | |
| 27 | −64.8893 | 4 | 1.6204 | 60.3 |
| 28 | 53.70398 | (D28) | | |

TABLE 27
Working Example 7

| Surface No. | K | A4 | A6 |
|---|---|---|---|
| 3 | 0 | −6.504E−08 | −1.78E−12 |
| 4 | 0 | 1.33887E−07 | −2.56E−12 |
| 12 | 0.049681265 | −1.0884E−07 | −5.112E−11 |
| Surface No. | A8 | A10 | A12 |
| 3 | −4E−16 | 0 | 0 |
| 4 | −9E−16 | 0 | 0 |
| 12 | −8.15E−14 | 1.13E−16 | −8E−20 |

TABLE 28
Working Example 7

| | |
|---|---|
| f | 387.99 |
| Fno | 2.85 |
| ω | 3.13 |

TABLE 29
Working Example 7

| | | | |
|---|---|---|---|
| β | 0 | 0.033 | 0.061 |
| D8 | 32.331 | 36.061 | 39.305 |
| D12 | 47.1 | 43.37 | 40.126 |
| D28 | 30.506 | 30.506 | 30.506 |

TABLE 30
Working Example 7

| | Starting | Focal |
|---|---|---|
| | Surface | Distance |
| GR1 | 1 | 201.049 |
| GR2 | 9 | −102.345 |
| GR3 | 13 | 999.997 |

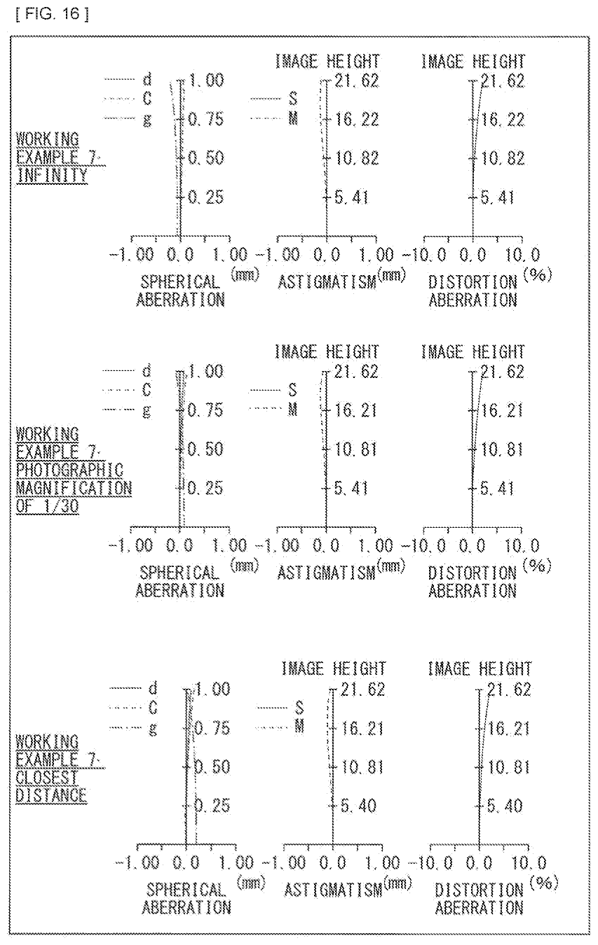

The top of FIG. 16 illustrates a longitudinal aberration upon the infinity focusing in the Numerical Working Example 7. The middle of FIG. 16 illustrates a longitudinal aberration upon the focusing at the photographic magnification of 1/30 in the Numerical Working Example 7. The bottom of FIG. 16 illustrates a longitudinal aberration upon the closest-distance focusing in the Numerical Working Example 7.

As can be appreciated from each of the aberration diagrams, each of the aberrations are favorably corrected in a balanced fashion upon the infinity focusing, upon the focusing at the photographic magnification of 1/30, and upon the closest-distance focusing in the imaging lens 7 according to the Numerical Working Example 7. Hence, it is clear that the imaging lens 7 according to the Numerical Working Example 7 has small performance variation upon focusing and superior image-forming performance.

### Numerical Working Example 8

[Table 31] illustrates basic lens data of Numerical Working Example 8 in which specific numerical values are applied to the imaging lens 8 illustrated in FIG. 8. Further, [Table 32] illustrates values of coefficients of aspherical surfaces. Further, [Table 33] illustrates a value of the focal distance f of the optical system as a whole upon the infinity focusing, a value of the F number (Fno), and a value of the half angle of view w.

Further, [Table 34] illustrates a value of a variable surface interval. In the Numerical Working Example 8, values of respective surface intervals D10 and D14 vary upon the focusing. Further, for reference, D30 in [Table 34] indicates a value of backfocus.

Further, [Table 35] illustrates a starting surface of a lens surface of each of the groups, and a value of the focal distance of each of the groups.

In the imaging lens 8 according to the Numerical Working Example 8, the first lens group GR1 includes, in order from the object side toward the image plane side, the protective filter glass (the lens L10) having the extremely-weak negative power, the positive first lens (the first lens L11), the positive second lens (the second lens L12), the negative third lens (the lens L13), and the positive fourth lens (the lens L14).

The second lens group GR2 includes, in order from the object side toward the image plane side, the positive fifth lens (the lens L21) and the negative sixth lens (the lens L22).

The third lens group GR3 includes, in order from the object side toward the image plane side, the lens in which the positive seventh lens (the lens L31) and the negative eighth lens (the lens L32) are attached together, the aperture stop St, the lens in which the positive ninth lens (the lens L33) and the negative tenth lens (the lens L34) are attached together, the negative eleventh lens (the lens L35), the positive twelfth lens (the lens L36), the lens in which the positive thirteenth lens (the lens L37) and the negative fourteenth lens (the lens L38) are attached together, and the negative fifteenth lens (the lens L39).

It is to be noted that, in the imaging lens 8 according to the Numerical Working Example 8, the lens in which the positive ninth lens and the negative tenth lens are attached together and the negative eleventh lens may be caused to travel in the direction perpendicular to the optical axis Z1 to thereby perform the image stabilization, upon the generation of camera shake.

TABLE 31
Working Example 8

| Surface No. | Ri | Di | ndi | νdi |
|---|---|---|---|---|
| 1 | 241.518 | 4 | 1.51679 | 64.1 |
| 2 | 203.4097 | 2 | | |
| 3 | 153.4212 | 16.66 | 1.59349 | 67 |
| 4 | 429.5615 | 86.17 | | |
| 5 (ASP) | 184.6932 | 24.95 | 1.437 | 95 |
| 6 (ASP) | −226.512 | 1 | | |
| 7 | −249.582 | 6 | 1.80518 | 25.4 |
| 8 | −2002.54 | 52.63 | | |
| 9 | 256.1918 | 15.39 | 1.437 | 95 |
| 10 | −219.12 | (D10) | | |
| 11 | 127.9321 | 6 | 2.10419 | 17 |
| 12 | −243.026 | 0.551 | | |
| 13 | −194.909 | 3.152 | 2.00069 | 25.4 |
| 14 (ASP) | 50.89725 | (D14) | | |
| 15 | 267.1373 | 11.63 | 1.70154 | 41.1 |
| 16 | −40.8909 | 2.034 | 1.84666 | 23.8 |
| 17 | −149.424 | 3 | | |
| 18 (STO) | ∞ | 3 | | |
| 19 | 111.2012 | 5.164 | 1.84666 | 23.7 |
| 20 | −113.297 | 1.8 | 1.7725 | 49.4 |
| 21 | 57.80746 | 3.283 | | |
| 22 | −1486.07 | 1.6 | 1.881 | 40.1 |
| 23 | 96.69385 | 6.306 | | |
| 24 | 36.31144 | 10 | 1.58143 | 40.8 |
| 25 | 293.1563 | 20.78 | | |
| 26 | 60.40927 | 12.5 | 1.64768 | 33.8 |
| 27 | −27.0217 | 3.65 | 2.00069 | 25.4 |
| 28 | −130.969 | 8.789 | | |
| 29 | 1075.668 | 2.214 | 1.62041 | 60.3 |
| 30 | 40.20287 | (D30) | | |

TABLE 32
Working Example 8

| Surface No. | K | A4 | A6 |
|---|---|---|---|
| 3 | 0 | −1.0769E−07 | −1.47E−12 |
| 4 | 0 | −4.064E−09 | 1.125E−11 |
| 12 | −0.0139 | −1.5155E−07 | −2.136E−10 |
| Surface No. | A8 | A10 | A12 |
| 3 | 0 | 0 | 0 |
| 4 | −2.1E−15 | 0 | 0 |
| 12 | −1.616E−13 | 1.82E−16 | −2.4E−19 |

TABLE 33
Working Example 8

| | |
|---|---|
| f | 388.00 |
| Fno | 2.85 |
| ω | 3.12 |

TABLE 34
Working Example 8

| | | | |
|---|---|---|---|
| β | 0 | 0.033 | 0.163 |
| D10 | 13.639 | 17.124 | 31.715 |
| D14 | 46.712 | 43.228 | 28.636 |
| D30 | 30.506 | 30.506 | 30.506 |

TABLE 35
Working Example 8

| | Starting | Focal |
|---|---|---|
| | Surface | Distance |
| GR1 | 1 | 193.747 |
| GR2 | 11 | −93.52 |
| GR3 | 15 | 840.748 |

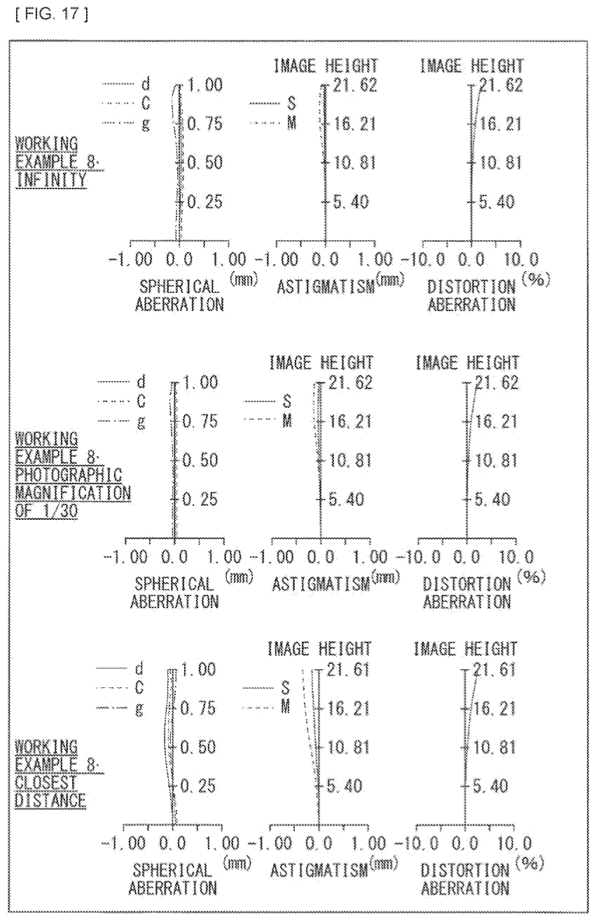

The top of FIG. 17 illustrates a longitudinal aberration upon the infinity focusing in the Numerical Working Example 8. The middle of FIG. 17 illustrates a longitudinal aberration upon the focusing at the photographic magnification of 1/30 in the Numerical Working Example 8. The bottom of FIG. 17 illustrates a longitudinal aberration upon the closest-distance focusing in the Numerical Working Example 8.

As can be appreciated from each of the aberration diagrams, each of the aberrations are favorably corrected in a balanced fashion upon the infinity focusing, upon the focusing at the photographic magnification of 1/30, and upon the closest-distance focusing in the imaging lens 8 according to the Numerical Working Example 8. Hence, it is clear that the imaging lens 8 according to the Numerical Working Example 8 has small performance variation upon focusing and superior image-forming performance.

### Numerical Working Example 9

[Table 36] illustrates basic lens data of Numerical Working Example 9 in which specific numerical values are applied to the imaging lens 9 illustrated in FIG. 9. Further, [Table 37] illustrates values of coefficients of aspherical surfaces. Further, [Table 38] illustrates a value of the focal distance f of the optical system as a whole upon the infinity focusing, a value of the F number (Fno), and a value of the half angle of view w.

Further, [Table 39] illustrates a value of a variable surface interval. In the Numerical Working Example 9, values of the respective surface intervals D10 and D14 vary upon the focusing. Further, for reference, D30 in [Table 39] indicates a value of backfocus.

Further, [Table 40] illustrates a starting surface of a lens surface of each of the groups, and a value of the focal distance of each of the groups.

In the imaging lens 9 according to the Numerical Working Example 9, the first lens group GR1 includes, in order from the object side toward the image plane side, the protective filter glass (the lens L10) having the extremely-weak positive power, the positive first lens (the first lens L11), the positive second lens (the second lens L12), the negative third lens (the lens L13), and the positive fourth lens (the lens L14).

The second lens group GR2 includes, in order from the object side toward the image plane side, the positive fifth lens (the lens L21) and the negative sixth lens (the lens L22).

The third lens group GR3 includes, in order from the object side toward the image plane side, the lens in which the positive seventh lens (the lens L31) and the negative eighth lens (the lens L32) are attached together, the aperture stop St, the lens in which the positive ninth lens (the lens L33) and the negative tenth lens (the lens L34) are attached together, the negative eleventh lens (the lens L35), the positive twelfth lens (the lens L36), the lens in which the positive thirteenth lens (the lens L37) and the negative fourteenth lens (the lens L38) are attached together, and the negative fifteenth lens (the lens L39).

It is to be noted that, in the imaging lens 9 according to the Numerical Working Example 9, the lens in which the positive ninth lens and the negative tenth lens are attached together and the negative eleventh lens may be caused to travel in the direction perpendicular to the optical axis Z1 to thereby perform the image stabilization, upon the generation of camera shake.

TABLE 36
Working Example 9

| Surface No. | Ri | Di | ndi | νdi |
|---|---|---|---|---|
| 1 | 512.1228 | 4 | 1.48748 | 70.4 |
| 2 | 756.6539 | 2 | | |
| 3 | 172.9667 | 12.26 | 1.59349 | 67 |
| 4 | 520.5524 | 135.8 | | |
| 5 (ASP) | 290.3625 | 12.47 | 1.437 | 95 |
| 6 (ASP) | −164.614 | 1 | | |
| 7 | −154.972 | 7 | 1.80518 | 25.4 |
| 8 | −617.061 | 28.4 | | |
| 9 | 118.4821 | 20 | 1.437 | 95 |
| 10 | −169.067 | (D10) | | |
| 11 | 146.6032 | 5.49 | 2.10419 | 17 |
| 12 | −265.152 | 0.5 | | |
| 13 | −211.122 | 2.7 | 2.00069 | 25.4 |
| 14 (ASP) | 48.83534 | (D14) | | |
| 15 | 136.9206 | 12.58 | 1.72341 | 37.9 |
| 16 | −35.5448 | 2 | 1.75519 | 27.5 |
| 17 | −434.778 | 3 | | |
| 18 (STO) | ∞ | 3 | | |
| 19 | 123.7633 | 5.619 | 1.84666 | 23.7 |
| 20 | −85.3315 | 1.8 | 1.7725 | 49.4 |
| 21 | 57.78292 | 3.392 | | |
| 22 | −977.483 | 1.6 | 1.881 | 40.1 |
| 23 | 92.09256 | 4.859 | | |
| 24 | 37.32566 | 10.56 | 1.58143 | 40.8 |
| 25 | 481.2392 | 20.3 | | |
| 26 | 62.11362 | 12.85 | 1.64768 | 33.8 |
| 27 | −27.5604 | 1.764 | 2.00069 | 25.4 |
| 28 | −125.061 | 9.69 | | |
| 29 | −225.367 | 2.728 | 1.6204 | 60.3 |
| 30 | 47.82889 | (D30) | | |

TABLE 37
Working Example 9

| Surface No. | K | A4 | A6 |
|---|---|---|---|
| 5 | 0 | −4.0792E−07 | 1.022E−11 |
| 6 | 0 | −2.5429E−07 | 8.198E−11 |
| 14 | −0.0069 | −1.5676E−07 | −2.171E−10 |
| Surface No. | A8 | A10 | A12 |
| 5 | −4.4E−15 | −3E−18 | 0 |
| 6 | −2.63E−14 | 1E−18 | 0 |
| 14 | −2.445E−13 | 4.36E−16 | −4.5E−19 |

TABLE 38
Working Example 9

| | |
|---|---|
| f | 388.00 |
| Fno | 2.85 |
| ω | 3.13 |

TABLE 39
Working Example 9

| | | | |
|---|---|---|---|
| β | 0 | 0.033 | 0.16 |
| D10 | 4.601 | 7.328 | 18.266 |
| D14 | 45.479 | 42.752 | 31.814 |
| D30 | 30.506 | 30.506 | 30.506 |

TABLE 40
Working Example 9

| | Starting | Focal |
|---|---|---|
| | Surface | Distance |
| GR1 | 1 | 174.664 |
| GR2 | 11 | −78.242 |
| GR3 | 15 | 546.143 |

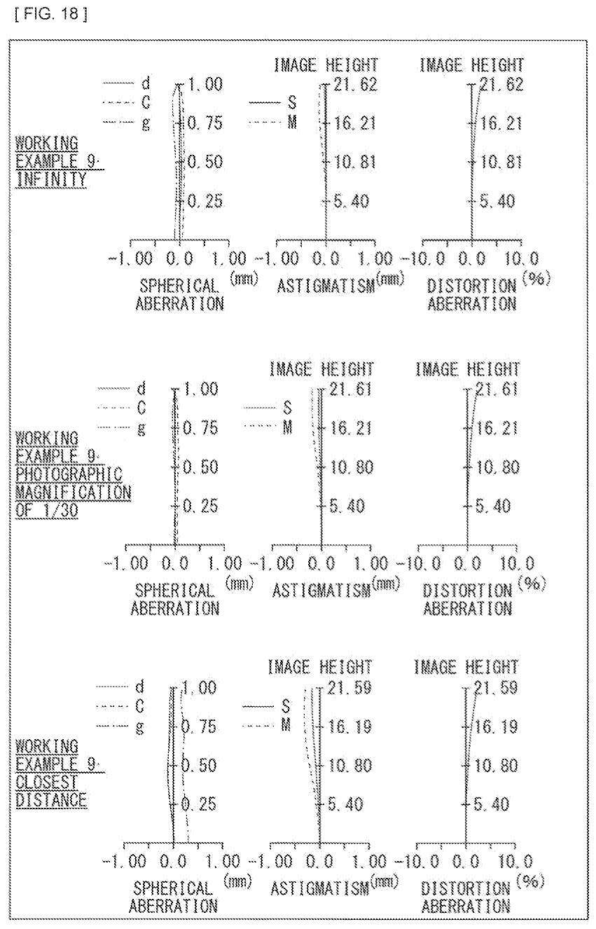

The top of FIG. 18 illustrates a longitudinal aberration upon the infinity focusing in the Numerical Working Example 9. The middle of FIG. 18 illustrates a longitudinal aberration upon the focusing at the photographic magnification of 1/30 in the Numerical Working Example 9. The bottom of FIG. 18 illustrates a longitudinal aberration upon the closest-distance focusing in the Numerical Working Example 9.

As can be appreciated from each of the aberration diagrams, each of the aberrations are favorably corrected in a balanced fashion upon the infinity focusing, upon the focusing at the photographic magnification of 1/30, and upon the closest-distance focusing in the imaging lens 9 according to the Numerical Working Example 9. Hence, it is clear that the imaging lens 9 according to the Numerical Working Example 9 has small performance variation upon focusing and superior image-forming performance.

### Other Numerical Data of Each Numerical Working Example

[Table 41] and [Table 42] summarize values related to the above-described conditional expressions for each of the Numerical Working Examples. As can be appreciated from the [Table 41], the values of each of the Numerical Working Examples fall within the numerical ranges of the respective conditional expressions (1) to (8). For the conditional expression (9), the values of the Numerical Working Examples 4, 5, 8, and 9 each fall within the numerical range thereof.

TABLE 41

| | | Working Example | | | | | | | | |
|---|---|---|---|---|---|---|---|---|---|---|
| Conditional Expression | | 1 | 2 | 3 | 4 | 5 | 6 | 7 | 8 | 9 |
| (1) | DL12/f | 0.409 | 0.400 | 0.210 | 0.210 | 0.226 | 0.210 | 0.250 | 0.222 | 0.350 |
| (2) | νdmin | 25.456 | 22.728 | 22.728 | 22.728 | 22.728 | 22.764 | 25.456 | 25.456 | 25.456 |
| (3) | ndL11 | 1.593 | 1.593 | 1.752 | 1.593 | 1.593 | 1.593 | 1.752 | 1.593 | 1.593 |
| | −1.036 × 10⁻⁶ × νdL11³ | 1.634 | 1.634 | 1.808 | 1.728 | 1.728 | 1.727 | 1.808 | 1.634 | 1.634 |
| | +2.481 × 10⁻⁴ × νdL11² | | | | | | | | | |
| | −1.996 × 10⁻² × νdL11 | | | | | | | | | |
| | +2.169 | | | | | | | | | |
| (4) | fL11/f1 | 1.700 | 0.977 | 0.834 | 0.438 | 0.850 | 2.500 | 2.500 | 2.030 | 2.466 |
| (5) | νdn | 25.456 | 22.728 | 22.728 | 22.728 | 22.728 | 22.764 | 25.456 | 25.456 | 25.456 |
| (6) | ΘgFn | 0.616 | 0.628 | 0.628 | 0.628 | 0.628 | 0.629 | 0.616 | 0.616 | 0.616 |
| (7) | νdL11 | 67.001 | 67.001 | 25.047 | 35.310 | 35.310 | 35.445 | 25.047 | 67.001 | 67.001 |
| (8) | ΦL12/ΦL11 | 0.597 | 0.532 | 0.742 | 0.647 | 0.625 | 0.822 | 0.800 | 0.799 | 0.656 |
| (9) | f/fL10 | — | — | — | −0.250 | 0.250 | — | — | −0.150 | 0.120 |

TABLE 42

| | Working Example | | | | | | | | |
|---|---|---|---|---|---|---|---|---|---|
| | 1 | 2 | 3 | 4 | 5 | 6 | 7 | 8 | 9 |
| DL12 | 158.524 | 155.200 | 81.585 | 101.850 | 131.780 | 81.480 | 97.000 | 86.177 | 135.800 |
| f | 388.005 | 388.000 | 387.995 | 485.000 | 582.000 | 387.991 | 387.992 | 388.000 | 388.002 |
| ndL11 | 1.593 | 1.593 | 1.752 | 1.593 | 1.593 | 1.593 | 1.752 | 1.593 | 1.593 |
| νdL11 | 67.001 | 67.001 | 25.047 | 35.310 | 35.310 | 35.445 | 25.047 | 67.001 | 67.001 |
| fL11 | 450.640 | 372.878 | 369.604 | 278.441 | 485.935 | 462.665 | 502.623 | 393.291 | 430.803 |
| f1 | 265.090 | 381.847 | 443.005 | 635.707 | 571.519 | 185.066 | 201.049 | 193.747 | 174.664 |
| νdn | 25.456 | 22.728 | 22.728 | 22.728 | 22.728 | 22.764 | 25.456 | 25.456 | 25.456 |
| ΘgFn | 0.616 | 0.628 | 0.628 | 0.628 | 0.628 | 0.629 | 0.616 | 0.616 | 0.616 |
| ΦL12 | 41.495 | 36.944 | 50.824 | 38.202 | 44.974 | 55.883 | 54.811 | 54.838 | 45.190 |
| ΦL11 | 69.500 | 69.500 | 68.500 | 59.000 | 71.930 | 68.000 | 68.500 | 68.600 | 68.900 |
| fL10 | — | — | — | −1940.1 | 2328.5 | — | — | −2587.0 | 3233.3 |

### 5. Other Embodiments

A technique of the disclosure is not limited to the description of the above-described embodiments and Working Examples, and may be modified and worked in a variety of ways.

For example, shapes and the numerical values of respective portions illustrated in each of the above-described Numerical Working Examples are each merely one embodying example to work the technology. Accordingly, a technical scope of the technology should not be construed in a limiting fashion by those shapes and numerical values.

Further, although the above-described embodiments and Working Examples have been described with reference to the configuration that substantially includes the three lens groups, a configuration may be employed that further includes a lens that does not have refractive power substantially.

Moreover, for example, the technology may have the following configurations.

[1]
An imaging lens including, in order from an object side toward an image plane side:
a first lens group having positive refractive power and including a plurality of optical elements;
a second lens group having positive refractive power; and
a third lens group having negative refractive power,
the second lens group traveling in an optical axis direction upon focusing,
the plurality of optical elements including, in order from the object side toward the image plane side, at least a first lens having positive refractive power and a second lens,
in which the following conditional expressions are satisfied:

0.20<DL12/f<0.5 (1)

νdmin>15 (2)
where
DL12 is an air space between the first lens and the second lens,
f is a focal distance, in a d-line, of entire system upon infinity focusing, and
νdmin is a minimum value of Abbe numbers of the respective plurality of optical elements.
   [2]
The imaging lens according to the foregoing [1], in which the following conditional expression is further satisfied:

1.53<ndL11<−1.036×10⁻⁶×νdL11³+2.481×10⁻⁴×νdL11²−1.996×10⁻²×νdL11+2.169. (3)
where
ndL11 is a refractive index, in a d-line, of the first lens, and
νdL11 is Abbe number of the first lens.
   [3]
The imaging lens according to the foregoing [1] or [2], in which the following conditional expression is further satisfied:

0.3<fL11/f1<2.7 (4)
where
fL11 is a focal distance, in a d-line, of the first lens, and
f1 is a focal distance, in a d-line, of the first lens group as a whole.
   [4]
The imaging lens according to any one of the foregoing [1] to [3], in which the plurality of optical elements further include a negative lens that satisfies the following conditional expression:

νdn<30 (5)
where
νdn is Abbe number of the negative lens.
   [5]
The imaging lens according to any one of the foregoing [1] to [4], in which the plurality of optical elements further include a negative lens that satisfies the following conditional expression:

ΘgFn>0.55 (6)
where
ΘgFn is a partial dispersion ratio of the negative lens.
   [6]
The imaging lens according to any one of the foregoing [1] to [5], in which the following conditional expression is further satisfied:

20<νdL11<69 (7)
where
νdL11 is Abbe number of the first lens.
   [7]
The imaging lens according to any one of the foregoing [1] to [6], in which the following conditional expression is further satisfied:

0.45<φL12/φL11<0.88 (8)
where
φL11 is an effective lens diameter of the first lens, and
φL12 is an effective lens diameter of the second lens.
   [8]
The imaging lens according to any one of the foregoing [1] to [7], in which the plurality of optical elements further include a lens that is disposed closest to the object side and that satisfies the following conditional expression (9):

−0.3<f/fL10<0.3 (9)
where
fL10 is a focal distance, in a d-line, of the lens disposed closest to the object side.
   [9]
An imaging lens including, in order from an object side toward an image plane side:
a first lens group having positive refractive power and including a plurality of optical elements;
a second lens group having negative refractive power; and
a third lens group having positive refractive power,
the second lens group traveling in an optical axis direction upon focusing,
the plurality of optical elements including, in order from the object side toward the image plane side, at least a first lens having positive refractive power and a second lens,
in which the following conditional expressions are satisfied:

0.20<DL12/f<0.5 (1)

νdmin>15 (2)
where
DL12 is an air space between the first lens and the second lens,
f is a focal distance, in a d-line, of entire system upon infinity focusing, and
νdmin is a minimum value of Abbe numbers of the respective plurality of optical elements.
   [10]
The imaging lens according to the foregoing [9], in which the following conditional expression is further satisfied:

1.53<ndL11<−1.036×10⁻⁶×νdL11³+2.481×10⁻⁴×νdL11²−1.996×10⁻²×νdL11+2.169. (3)
where
ndL11 is a refractive index, in a d-line, of the first lens, and
νdL11 is Abbe number of the first lens.
The imaging lens according to the foregoing [9] or [10], in which the following conditional expression is further satisfied:

0.3<fL11/f1<2.7 (4)
where
fL11 is a focal distance, in a d-line, of the first lens, and
f1 is a focal distance, in a d-line, of the first lens group as a whole.
   [12]
The imaging lens according to any one of the foregoing [9] to [11], in which the plurality of optical elements further include a negative lens that satisfies the following conditional expression:

νdn<30 (5)
where
νdn is Abbe number of the negative lens.
   [13]
The imaging lens according to any one of the foregoing [9] to [12], in which the plurality of optical elements further include a negative lens that satisfies the following conditional expression:

ΘgFn>0.55 (6)
where
ΘgFn is a partial dispersion ratio of the negative lens.
   [14]
The imaging lens according to any one of the foregoing [9] to [13], in which the following conditional expression is further satisfied:

20<νdL11<69 (7)
where
νdL11 is Abbe number of the first lens.
   [15]

The imaging lens according to any one of the foregoing [9] to [14], in which the following conditional expression is further satisfied:

0.45<φL12/φL11<0.88 (8)
where
φL11 is an effective lens diameter of the first lens, and
φL12 is an effective lens diameter of the second lens.
   [16]

The imaging lens according to any one of the foregoing [9] to [15], in which the plurality of optical elements further include a lens that is disposed closest to the object side and that satisfies the following conditional expression (9):

−0.3<f/fL10<0.3 (9)
where
fL10 is a focal distance, in a d-line, of the lens disposed closest to the object side.
   [17]
An imaging apparatus including an imaging lens and an imaging device, the imaging device outputting an imaging signal that corresponds to an optical image formed by the imaging lens, the imaging lens including, in order from an object side toward an image plane side:
a first lens group having positive refractive power and including a plurality of optical elements;
a second lens group having positive refractive power; and
a third lens group having negative refractive power,
the second lens group traveling in an optical axis direction upon focusing,
the plurality of optical elements including, in order from the object side toward the image plane side, at least a first lens having positive refractive power and a second lens,
in which the following conditional expressions are satisfied:

0.20<DL12/R0.5 (1)

νdmin>15 (2)
where
DL12 is an air space between the first lens and the second lens,
f is a focal distance, in a d-line, of entire system upon infinity focusing, and
νdmin is a minimum value of Abbe numbers of the respective plurality of optical elements.
   [18]
An imaging apparatus including an imaging lens and an imaging device, the imaging device outputting an imaging signal that corresponds to an optical image formed by the imaging lens, the imaging lens including, in order from an object side toward an image plane side:
a first lens group having positive refractive power and including a plurality of optical elements;
a second lens group having negative refractive power; and
a third lens group having positive refractive power,
the second lens group traveling in an optical axis direction upon focusing,
the plurality of optical elements including, in order from the object side toward the image plane side, at least a first lens having positive refractive power and a second lens,
in which the following conditional expressions are satisfied:

0.20<DL12/R0.5 (1)

νdmin>15 (2)
where
DL12 is an air space between the first lens and the second lens,
f is a focal distance, in a d-line, of entire system upon infinity focusing, and
νdmin is a minimum value of Abbe numbers of the respective plurality of optical elements.

This application claims the priority of Japanese Priority Patent Application JP2016-218344 filed with the Japan Patent Office on Nov. 8, 2016, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An imaging lens comprising, in order from an object side toward an image plane side:
a first lens group having positive refractive power and including a plurality of optical elements;
a second lens group having positive refractive power; and
a third lens group having negative refractive power,
the second lens group traveling in an optical axis direction upon focusing,
the plurality of optical elements including, in order from the object side toward the image plane side, at least a first lens having positive refractive power and a second lens,
wherein the following conditional expressions are satisfied:
0.20<DL12/R0.5 (1)
νdmin>15 (2)
where
DL12 is an air space between the first lens and the second lens,
f is a focal distance, in a d-line, of entire system upon infinity focusing, and
νdmin is a minimum value of Abbe numbers of the respective plurality of optical elements.

2. The imaging lens according to claim 1, wherein the following conditional expression is further satisfied:
1.53<ndL11<−1.036×10⁻⁶×νdL11³+2.481×10⁻⁴×νdL11²−1.996×10⁻²×νdL11+2.169. (3)
where
ndL11 is a refractive index, in a d-line, of the first lens, and
νdL11 is Abbe number of the first lens.

3. The imaging lens according to claim 1, wherein the following conditional expression is further satisfied:
0.3<fL11/f1<2.7 (4)
where
fL11 is a focal distance, in a d-line, of the first lens, and
f1 is a focal distance, in a d-line, of the first lens group as a whole.

4. The imaging lens according to claim 1, wherein the plurality of optical elements further include a negative lens that satisfies the following conditional expression:
νdn<30 (5)
where
νdn is Abbe number of the negative lens.

5. The imaging lens according to claim 1, wherein the plurality of optical elements further include a negative lens that satisfies the following conditional expression:
ΘgFn>0.55 (6)
where
ΘgFn is a partial dispersion ratio of the negative lens.

6. The imaging lens according to claim 1, wherein the following conditional expression is further satisfied:
20<νdL11<69 (7)
where
νdL11 is Abbe number of the first lens.

7. The imaging lens according to claim 1, wherein the following conditional expression is further satisfied:
0.45<φL12/φL11<0.88 (8)
where
φL11 is an effective lens diameter of the first lens, and
φL12 is an effective lens diameter of the second lens.

8. The imaging lens according to claim 1, wherein the plurality of optical elements further include a lens that is disposed closest to the object side and that satisfies the following conditional expression (9):
−0.3<f/fL10<0.3 (9)
where
fL10 is a focal distance, in a d-line, of the lens disposed closest to the object side.

9. An imaging lens comprising, in order from an object side toward an image plane side:
a first lens group having positive refractive power and including a plurality of optical elements;
a second lens group having negative refractive power; and
a third lens group having positive refractive power,
the second lens group traveling in an optical axis direction upon focusing,
the plurality of optical elements including, in order from the object side toward the image plane side, at least a first lens having positive refractive power and a second lens,
wherein the following conditional expressions are satisfied:
0.20<DL12/f<0.5 (1)
νdmin>15 (2)
where
DL12 is an air space between the first lens and the second lens,
f is a focal distance, in a d-line, of entire system upon infinity focusing, and
νdmin is a minimum value of Abbe numbers of the respective plurality of optical elements.

10. The imaging lens according to claim 9, wherein the following conditional expression is further satisfied:
1.53<ndL11<−1.036×10⁻⁶×νdL11³+2.481×10⁻⁴×νdL11²−1.996×10⁻²×νdL11+2.169. (3)
where
ndL11 is a refractive index, in a d-line, of the first lens, and
νdL11 is Abbe number of the first lens.

11. The imaging lens according to claim 9, wherein the following conditional expression is further satisfied:
0.3<fL11/f1<2.7 (4)
where
fL11 is a focal distance, in a d-line, of the first lens, and
f1 is a focal distance, in a d-line, of the first lens group as a whole.

12. The imaging lens according to claim 9, wherein the plurality of optical elements further include a negative lens that satisfies the following conditional expression:
νdn<30 (5)
where
νdn is Abbe number of the negative lens.

13. The imaging lens according to claim 9, wherein the plurality of optical elements further include a negative lens that satisfies the following conditional expression:
ΘgFn>0.55 (6)
where
ΘgFn is a partial dispersion ratio of the negative lens.

14. The imaging lens according to claim 9, wherein the following conditional expression is further satisfied:
20<νdL11<69 (7)
where
νdL11 is Abbe number of the first lens.

15. The imaging lens according to claim 9, wherein the following conditional expression is further satisfied:
0.45<φL12/φL11<0.88 (8)
where
φL11 is an effective lens diameter of the first lens, and
φL12 is an effective lens diameter of the second lens.

16. The imaging lens according to claim 9, wherein the plurality of optical elements further include a lens that is disposed closest to the object side and that satisfies the following conditional expression (9):
−0.3<f/fL10<0.3 (9)
where
fL10 is a focal distance, in a d-line, of the lens disposed closest to the object side.

17. An imaging apparatus including an imaging lens and an imaging device, the imaging device outputting an imaging signal that corresponds to an optical image formed by the imaging lens, the imaging lens comprising, in order from an object side toward an image plane side:
a first lens group having positive refractive power and including a plurality of optical elements;
a second lens group having positive refractive power; and
a third lens group having negative refractive power,
the second lens group traveling in an optical axis direction upon focusing,
the plurality of optical elements including, in order from the object side toward the image plane side, at least a first lens having positive refractive power and a second lens,
wherein the following conditional expressions are satisfied:
0.20<DL12/R0.5 (1)
νdmin>15 (2)
where
DL12 is an air space between the first lens and the second lens,
f is a focal distance, in a d-line, of entire system upon infinity focusing, and
νdmin is a minimum value of Abbe numbers of the respective plurality of optical elements.

18. An imaging apparatus including an imaging lens and an imaging device, the imaging device outputting an imaging signal that corresponds to an optical image formed by the imaging lens, the imaging lens comprising, in order from an object side toward an image plane side:
a first lens group having positive refractive power and including a plurality of optical elements;
a second lens group having negative refractive power; and
a third lens group having positive refractive power,
the second lens group traveling in an optical axis direction upon focusing,
the plurality of optical elements including, in order from the object side toward the image plane side, at least a first lens having positive refractive power and a second lens,
wherein the following conditional expressions are satisfied:
0.20<DL12/R0.5 (1)
νdmin>15 (2)
where
DL12 is an air space between the first lens and the second lens,
f is a focal distance, in a d-line, of entire system upon infinity focusing, and
νdmin is a minimum value of Abbe numbers of the respective plurality of optical elements.
